(19) United States
(12) Patent Application Publication
(10) Pub. No.: US 2026/0073577 A1
(43) Pub. Date: Mar. 12, 2026

(54) ENHANCING MAP DATA

(71) Applicant: QUALCOMM Incorporated, San Diego, CA (US)

(72) Inventors: Per Albert SIDEN, Linköping (SE); Per CRONVALL, Linköping (SE)

(21) Appl. No.: 18/828,969

(22) Filed: Sep. 9, 2024

(51) Int. Cl. G06T 11/00; G06V 10/764; G06V 10/774; G06V 10/82; G06V 20/56

(52) U.S. Cl. CPC G06T 11/00; G06V 10/764; G06V 10/774; G06V 10/82; G06V 20/588

(57) ABSTRACT

Systems and techniques are described herein for generating map data. For instance, a method for generating map data is provided. The method may include processing sensor data representative of a scene using a bird's-eye-view (BEV) detector to generate a BEV map of the scene; processing the BEV map using a BEV spatial prior model to generate one or more priors; and refining the BEV map, based on the one or more priors, to generate a refined BEV map.

### TECHNICAL FIELD

The present disclosure generally relates to map data. For example, aspects of the present disclosure include systems and techniques for refining bird's-eye-view (BEV) maps.

### BACKGROUND

A bird's-eye-view (BEV) map of a scene includes a representation of the scene from an elevated point of view (e.g., from above the scene). A BEV map may be represented by a three-dimensional numerical tensor, which can be interpreted as a multi-channel image. Each pixel in this image may for example indicate a likelihood that a corresponding region in the scene contains a lane boundary, a road boundary, or a pedestrian crossing.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary presents certain concepts relating to one or more aspects relating to the mechanisms disclosed herein in a simplified form to precede the detailed description presented below.

Systems and techniques are described for generating map data. According to at least one example, a method is provided for generating map data. The method includes: processing sensor data representative of a scene using a bird's-eye-view (BEV) detector to generate a BEV map of the scene; processing the BEV map using a BEV spatial prior model to generate one or more priors; and refining the BEV map, based on the one or more priors, to generate a refined BEV map.

In another example, an apparatus for generating map data is provided that includes at least one memory and at least one processor (e.g., configured in circuitry) coupled to the at least one memory. The at least one processor configured to: process sensor data representative of a scene using a bird's-eye-view (BEV) detector to generate a BEV map of the scene; process the BEV map using a BEV spatial prior model to generate one or more priors; and refine the BEV map, based on the one or more priors, to generate a refined BEV map.

In another example, a non-transitory computer-readable medium is provided that has stored thereon instructions that, when executed by one or more processors, cause the one or more processors to: process sensor data representative of a scene using a bird's-eye-view (BEV) detector to generate a BEV map of the scene; process the BEV map using a BEV spatial prior model to generate one or more priors; and refine the BEV map, based on the one or more priors, to generate a refined BEV map.

In another example, an apparatus for generating map data is provided. The apparatus includes: means for processing sensor data representative of a scene using a bird's-eye-view (BEV) detector to generate a BEV map of the scene; means for processing the BEV map using a BEV spatial prior model to generate one or more priors; and means for refining the BEV map, based on the one or more priors, to generate a refined BEV map.

In another example, a method is provided for generating map data. The method includes: processing sensor data representative of a scene using a bird's-eye-view (BEV) detector to generate a BEV map of the scene; and processing the BEV map using an enhancer model to generate a refined BEV map.

In another example, an apparatus for generating map data is provided that includes at least one memory and at least one processor (e.g., configured in circuitry) coupled to the at least one memory. The at least one processor configured to: process sensor data representative of a scene using a bird's-eye-view (BEV) detector to generate a BEV map of the scene; and process the BEV map using an enhancer model to generate a refined BEV map.

In another example, a non-transitory computer-readable medium is provided that has stored thereon instructions that, when executed by one or more processors, cause the one or more processors to: process sensor data representative of a scene using a bird's-eye-view (BEV) detector to generate a BEV map of the scene; and process the BEV map using an enhancer model to generate a refined BEV map.

In another example, an apparatus for generating map data is provided. The apparatus includes: means for processing sensor data representative of a scene using a bird's-eye-view (BEV) detector to generate a BEV map of the scene; and means for processing the BEV map using an enhancer model to generate a refined BEV map.

In another example, a method is provided for generating map data. The method includes: obtaining sensor data representative of a scene; and processing the sensor data using a bird's-eye-view (BEV) detector to generate a BEV map of the scene, wherein the BEV detector is trained using priors determined by a BEV spatial prior model.

In another example, an apparatus for generating map data is provided that includes at least one memory and at least one processor (e.g., configured in circuitry) coupled to the at least one memory. The at least one processor configured to: obtain sensor data representative of a scene; and process the sensor data using a bird's-eye-view (BEV) detector to generate a BEV map of the scene, wherein the BEV detector is trained using priors determined by a BEV spatial prior model

In another example, a non-transitory computer-readable medium is provided that has stored thereon instructions that, when executed by one or more processors, cause the one or more processors to: obtain sensor data representative of a scene; and process the sensor data using a bird's-eye-view (BEV) detector to generate a BEV map of the scene, wherein the BEV detector is trained using priors determined by a BEV spatial prior model.

In another example, an apparatus for generating map data is provided. The apparatus includes: means for obtaining sensor data representative of a scene; and means for processing the sensor data using a bird's-eye-view (BEV) detector to generate a BEV map of the scene, wherein the BEV detector is trained using priors determined by a BEV spatial prior model.

In another example, a method is provided for generating map data. The method includes: encoding sensor data to generate features using an encoder of a bird's-eye-view (BEV) detector, wherein the sensor data is representative of a scene; and decoding the features using a decoder of a BEV spatial prior model to generate a BEV map of the scene.

In another example, an apparatus for generating map data is provided that includes at least one memory and at least one processor (e.g., configured in circuitry) coupled to the at least one memory. The at least one processor configured to: encode sensor data to generate features using an encoder of a bird's-eye-view (BEV) detector, wherein the sensor data is representative of a scene; and decode the features using a decoder of a BEV spatial prior model to generate a BEV map of the scene.

In another example, a non-transitory computer-readable medium is provided that has stored thereon instructions that, when executed by one or more processors, cause the one or more processors to: encode sensor data to generate features using an encoder of a bird's-eye-view (BEV) detector, wherein the sensor data is representative of a scene; and decode the features using a decoder of a BEV spatial prior model to generate a BEV map of the scene.

In another example, an apparatus for generating map data is provided. The apparatus includes: means for encoding sensor data to generate features using an encoder of a bird's-eye-view (BEV) detector, wherein the sensor data is representative of a scene; and means for decoding the features using a decoder of a BEV spatial prior model to generate a BEV map of the scene.

In another example, a method is provided for generating map data. The method includes: processing sensor data representative of a scene using a bird's-eye-view (BEV) detector to generate a BEV map of the scene; and enhancing the BEV map using a BEV spatial prior model to generate a refined BEV map.

In another example, an apparatus for generating map data is provided that includes at least one memory and at least one processor (e.g., configured in circuitry) coupled to the at least one memory. The at least one processor configured to: process sensor data representative of a scene using a bird's-eye-view (BEV) detector to generate a BEV map of the scene; and enhance the BEV map using a BEV spatial prior model to generate a refined BEV map.

In another example, a non-transitory computer-readable medium is provided that has stored thereon instructions that, when executed by one or more processors, cause the one or more processors to: process sensor data representative of a scene using a bird's-eye-view (BEV) detector to generate a BEV map of the scene; and enhance the BEV map using a BEV spatial prior model to generate a refined BEV map.

In another example, an apparatus for generating map data is provided. The apparatus includes: means for processing sensor data representative of a scene using a bird's-eye-view (BEV) detector to generate a BEV map of the scene; and means for enhancing the BEV map using a BEV spatial prior model to generate a refined BEV map.

In some aspects, one or more of the apparatuses described herein is, can be part of, or can include an extended reality device (e.g., a virtual reality (VR) device, an augmented reality (AR) device, or a mixed reality (MR) device), a vehicle (or a computing device, system, or component of a vehicle), a mobile device (e.g., a mobile telephone or so-called “smart phone”, a tablet computer, or other type of mobile device), a smart or connected device (e.g., an Internet-of-Things (IoT) device), a wearable device, a personal computer, a laptop computer, a video server, a television (e.g., a network-connected television), a robotics device or system, or other device. In some aspects, each apparatus can include an image sensor (e.g., a camera) or multiple image sensors (e.g., multiple cameras) for capturing one or more images. In some aspects, each apparatus can include one or more displays for displaying one or more images, notifications, and/or other displayable data. In some aspects, each apparatus can include one or more speakers, one or more light-emitting devices, and/or one or more microphones. In some aspects, each apparatus can include one or more sensors. In some cases, the one or more sensors can be used for determining a location of the apparatuses, a state of the apparatuses (e.g., a tracking state, an operating state, a temperature, a humidity level, and/or other state), and/or for other purposes.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

Illustrative examples of the present application are described in detail below with reference to the following figures:

FIG. 1 includes three example BEV maps;

FIG. 2 is a block diagram illustrating an example system for generating BEV maps;

FIG. 3 is a block diagram illustrating a first example system for generating map data (e.g., BEV maps), according to various aspects of the present disclosure;

FIG. 4 is a block diagram illustrating a process for training the BEV spatial prior machine-learning model of FIG. 3, according to various aspects of the present disclosure;

FIG. 5 is a flow diagram illustrating a first example process for generating map data, in accordance with aspects of the present disclosure;

FIG. 6 is a block diagram illustrating a second example system for generating BEV maps, according to various aspects of the present disclosure;

FIG. 7 is a block diagram illustrating a process for training the enhancer of FIG. 6, according to various aspects of the present disclosure;

FIG. 8 is a flow diagram illustrating a second example process for generating map data, in accordance with aspects of the present disclosure;

FIG. 9 is a block diagram illustrating a third example system for generating BEV maps, according to various aspects of the present disclosure;

FIG. 10 is a block diagram illustrating a process for training the BEV detector of FIG. 9, according to various aspects of the present disclosure;

FIG. 11 is a flow diagram illustrating a third example process for generating map data, in accordance with aspects of the present disclosure;

FIG. 12 is a block diagram illustrating a fourth example system for generating BEV maps, according to various aspects of the present disclosure;

FIG. 13 is a block diagram illustrating a process for training the BEV spatial prior machine-learning model and encoder of FIG. 12, according to various aspects of the present disclosure;

FIG. 14 is a flow diagram illustrating a fourth example process for generating map data, in accordance with aspects of the present disclosure;

FIG. 15 is a block diagram illustrating a fifth example system for generating BEV maps, according to various aspects of the present disclosure;

FIG. 16 is a block diagram illustrating a process for training the enhancer of FIG. 15, according to various aspects of the present disclosure;

FIG. 17 is a flow diagram illustrating a fifth example process for generating map data (e.g., a BEV map), in accordance with aspects of the present disclosure;

FIG. 18 is a block diagram illustrating an example of a deep learning neural network that can be used to perform various tasks, according to some aspects of the disclosed technology;

FIG. 19 is a block diagram illustrating an example of a convolutional neural network (CNN), according to various aspects of the present disclosure; and

FIG. 20 is a block diagram illustrating an example computing-device architecture of an example computing device which can implement the various techniques described herein.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the exemplary aspects will provide those skilled in the art with an enabling description for implementing an exemplary aspect. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage, or mode of operation.

As mentioned above, a bird's-eye-view (BEV) map of a scene may include a representation of regions of the scene. A BEV map may be, or may include, a map in the traditional sense (i.e., a representation of a geographical region). Additionally or alternatively, a BEV map may be, or may include, a map in the same sense as “feature map” or “segmentation map” (e.g., a tensor of numerical values that are the output of a mapping provided by e.g. a neural network).

A BEV map may be represented by a three-dimensional numerical tensor, which can be interpreted as a multi-channel image. In some aspects, a BEV map may be, or may include, a “BEV semantic map” in which each element of the map corresponds to a class. For example, a first given element of a BEV map may indicate that a first region of a scene represented by the map is a crosswalk. A second given element of the BEV map may indicate that a second region of the scene is a lane boundary.

In some aspects, a BEV map may be, or may include, a “BEV probability map” in which each of the elements of a BEV map may include a vector of values that collectively indicate a likelihood that a corresponding region of the scene belongs to one or more classes. For example, a given element of a BEV map may include a vector of values, a first value of the vector may indicate a likelihood that a corresponding region of the scene is a lane boundary, a second value of the vector may indicate a likelihood that the corresponding region of the scene is a road boundary, and a third value of the vector may indicate a likelihood that the corresponding region of the scene is a pedestrian crossing. The vector may be, for example, [0.8, 0.1, 0.1], indicating a 80% likelihood that the region of the scene is a lane boundary, a 10% likelihood that the region of the scene is a road boundary, and a 10% likelihood that the region of the scene is pedestrian crossing.

BEV maps may be useful for driving systems (e.g., autonomous, semi-autonomous, or assisted driving systems, such as an advanced driver assistance system (ADAS)). Autonomous vehicles may use BEV maps to make determinations about steering, accelerating, braking, path planning, and/or to provide information to a driver, etc. These capabilities may become even more important for higher levels of autonomy, such as autonomy levels 3 and higher. For example, autonomy level 0 requires full control from the driver as the vehicle has no autonomous driving system, and autonomy level 1 involves basic assistance features, such as cruise control, in which case the driver of the vehicle is in full control of the vehicle. Autonomy level 2 refers to semi-autonomous driving, where the vehicle can perform functions, such as drive in a straight path, stay in a particular lane, control the distance from other vehicles in front of the vehicle, or other functions own. Autonomy levels 3, 4, and 5 include much more autonomy. For example, autonomy level 3 refers to an on-board autonomous driving system that can take over all driving functions in certain situations, where the driver remains ready to take over at any time if needed. Autonomy level 4 refers to a fully autonomous experience without requiring a user's help, even in complicated driving situations (e.g., on highways and in heavy city traffic). With autonomy level 4, a person may still remain in the driver's seat behind the steering wheel. Vehicles operating at autonomy level 4 can communicate and inform other vehicles about upcoming maneuvers (e.g., a vehicle is changing lanes, making a turn, stopping, etc.). Autonomy level 5 vehicles fully autonomous, self-driving vehicles that operate autonomously in all conditions. A human operator is not needed for the vehicle to take any action. Thus, autonomous, semi-autonomous, or assisted driving systems are an example of where the systems and techniques described may be employed. Also, the systems and techniques described herein may be employed in non-autonomous (e.g., human controlled) vehicles. For example, the systems and techniques may provide information to a driver based on a BEV map.

BEV neural networks (NNs) may be used in vehicles (e.g., autonomous vehicles, semi-autonomous vehicles, etc.) to generate BEV maps. BEV NNs may be trained to detect road objects (e.g., lane boundaries, road boundaries, and pedestrian crossings) based on sensor inputs (e.g., image data from cameras, and/or point-cloud data from radio detection and ranging (RADAR) systems and/or light detection and ranging (LIDAR) systems). In some cases, BEV NNs may produce blurry maps or multiple detections of the same object. Some systems apply post-processing to BEV maps to generate BEV maps without blur/double detections for downstream use in an ADAS system.

Systems, apparatuses, methods (also referred to as processes), and computer-readable media (collectively referred to herein as “systems and techniques”) are described herein for generating BEV maps. For example, the systems and techniques described herein may use a data driven approach for postprocessing using a separate generative model which may be referred to as BEV spatial prior machine-learning model. The BEV spatial prior machine-learning model may be trained to learn the spatial dependencies from ground truth BEV maps. The BEV spatial prior machine-learning model may be used to convert unrealistic raw output predictions from a BEV detector into more realistic predictions which have the same spatial characteristics as the ground truth maps on which the BEV spatial prior machine-learning model is trained. The systems and techniques may be an improvement over other postprocessing techniques, for example, rule-based postprocessing techniques because such techniques do not involve learning from data.

The systems and techniques may include a BEV spatial prior machine-learning model that may be trained (e.g., through an unsupervised training process) based on ground-truth BEV maps. In some aspects, the BEV spatial prior machine-learning model may be trained to receive a BEV map and generate a score indicating a likelihood that the BEV map is accurate. In other words, the BEV spatial prior machine-learning model may be trained to indicate a score indicative of whether an input BEV map accurately reflects a real scene. The BEV spatial prior machine-learning model may reflect spatial dependencies learned through training.

In some aspects, the systems and techniques may include a BEV detector that may generate a BEV map including a number of vectors or values and a score matrix including a corresponding number of scores. Each score of the score matrix may indicate a confidence of the BEV detector in a corresponding vector or value of the BEV map. Additionally, the systems and techniques may process the BEV map using a BEV spatial prior machine-learning model. The BEV spatial prior machine-learning model may generate a prior indicative of the likelihood that the BEV map is accurate. The systems and techniques may solve an optimization problem including the score output by the BEV detector and the prior output by the BEV spatial prior machine-learning model.

Various aspects of the application will be described with respect to the figures below.

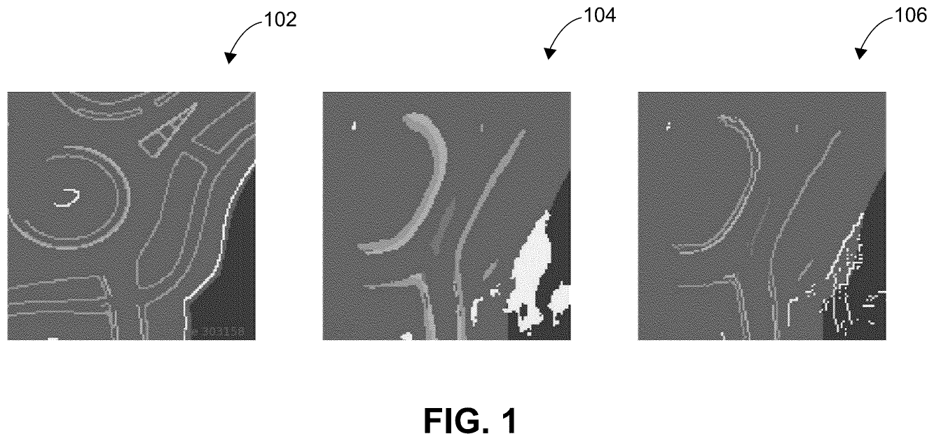

FIG. 1 includes three example BEV maps including a ground-truth BEV map 102, a predicted BEV map 104, and a processed BEV map 106. Ground-truth BEV map 102, predicted BEV map 104, and processed BEV map 106, may each include pixels representing regions in the scene.

A pixel of ground-truth BEV map 102 may indicate a class or a list of classes that are present in the region corresponding to the pixel. For example, a pixel of ground-truth BEV map 102 may include values indicating all classes present in the region of the scene corresponding to the pixel (e.g., a 1 indicating a lane boundary and/or a 4 indicating a drivable surface). Additionally or alternatively, a pixel of ground-truth BEV map 102 may include a binary vector, for example, a vector [1, 0, 0, 1] indicating a lane boundary, not a road boundary, not a crosswalk, and a drivable surface.

Pixels of BEV map 104 and processed BEV map 106, may indicate a determined likelihood that respective regions in the scene are of a class of a list of possible classes. The list of possible classes may include, for example, road or travelable surfaces, non-road surfaces, lane boundaries, road boundaries, pedestrian crossings, and/or other road markings. for example, the pixels of each of predicted BEV map 104 and processed BEV map 106 may include a vector of values, for example, representing a likelihood that a given pixel represents a region of each of the list of possible classes. For example, a given pixel may have a vector [0.8, 0.1, 0.1], indicating an 80% likelihood that the region of the scene is a lane boundary, a 10% likelihood that the region of the scene is a road boundary, and a 10% likelihood that the region of the scene is pedestrian crossing.

For illustrative purposes, ground-truth BEV map 102, predicted BEV map 104, and processed BEV map 106 are quantized or thresholded such that for each pixel one class is displayed. For example, for each pixel, a most-likely class may be selected. As another example, for each pixel, a class that exceeds a probability may be selected.

Ground-truth BEV map 102 may be, or may include, pixels that are an accurate representation of classes of points in a scene. Ground-truth BEV map 102 may be determined according to any suitable means, such as by an annotation process. For example, a human annotator may assign classes to pixels of ground-truth BEV map 102. As an example, ground-truth BEV map 102 may be determined by measuring the scene or capturing multiple sensor inputs (e.g., image data from cameras, and/or point-cloud data from radio detection and ranging (RADAR) systems and/or light detection and ranging (LIDAR) systems) from multiple different positions within the scene, then generating ground-truth BEV map 102 based on the multiple sensor inputs.

Predicted BEV map 104 may be a BEV map predicted by a BEV NN based on sensor inputs from one point within the scene. For example, predicted BEV map 104 may be an example of what a BEV NN may generate while a vehicle is at a region of the scene represented by predicted BEV map 104 based on sensor data captured from the point within the scene. Lane and road boundaries appear thicker in predicted BEV map 104 than in ground-truth BEV map 102. The thickness may be based on an uncertainty of the BEV NN in generating predicted BEV map 104.

Processed BEV map 106 may be predicted BEV map 104 after postprocessing. For example, predicted BEV map 104 may be processed according to a rule-based postprocessing technique to generate processed BEV map 106. The road and lane boundaries in processed BEV map 106 may be thinner than the road and lane boundaries in predicted BEV map 104. The rule-based postprocessing may, among other things, thin road and lane boundaries. Processed BEV map 106 may be an improvement over predicted BEV map 104, but processed BEV map 106 does not accurately reflect the scene as can be seen from a comparison of processed BEV map 106 to ground-truth BEV map 102.

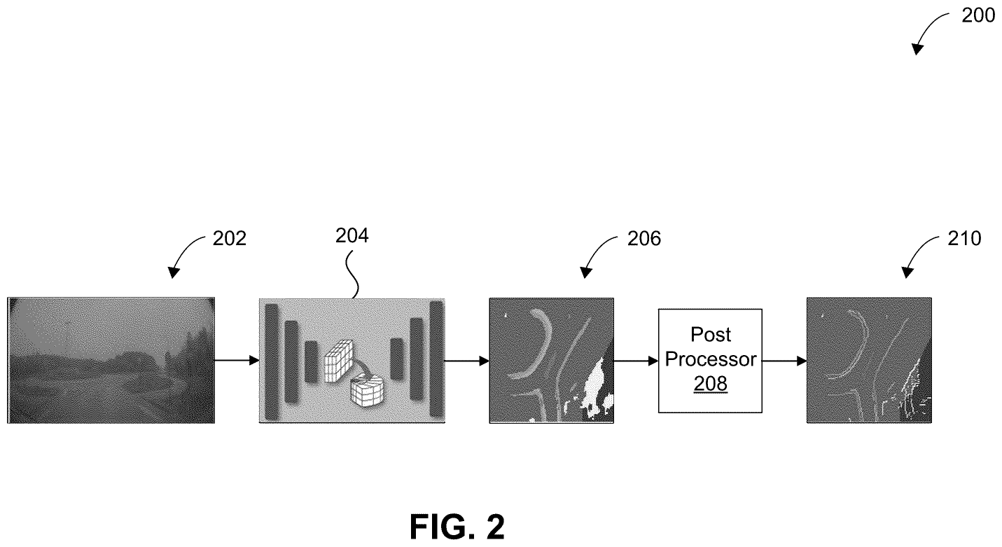

FIG. 2 is a block diagram illustrating an example system 200 for generating BEV maps. In general, a BEV detector 204 may generate a predicted BEV map 206 based on sensor data 202 and a post processor 208 may generate a processed BEV map 210 based on predicted BEV map 206.

Sensor data 202 may be, or may include, sensor data (e.g., image data from cameras, and/or point-cloud data from RADAR systems and/or LIDAR systems) captured from a point in a scene. Sensor data 202 may be captured by any number of cameras, RADAR systems, and/or LIDAR systems.

BEV detector 204 may encode sensor data 202 as features, project the features from an image-based feature space into a BEV-based feature space, and decode the projected features to generate predicted BEV map 206. BEV detector 204 may include an encoder network, including any number of layers, to encode sensor data 202. Additionally, BEV detector 204 may include a decoder network, including any number of layers, to decode the projected features.

Post processor 208 may be a rule-based postprocessor. For example, post processor 208 may generate processed BEV map 210 from predicted BEV map 206 based on rules, such as rules that cause post processor 208 to thin road and/or lane boundaries.

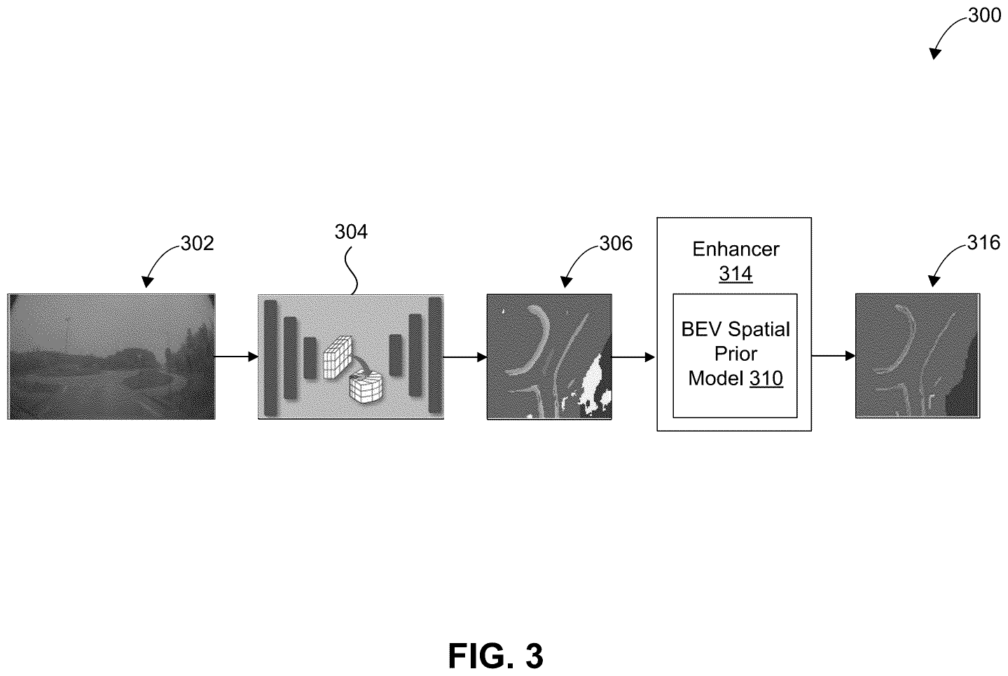

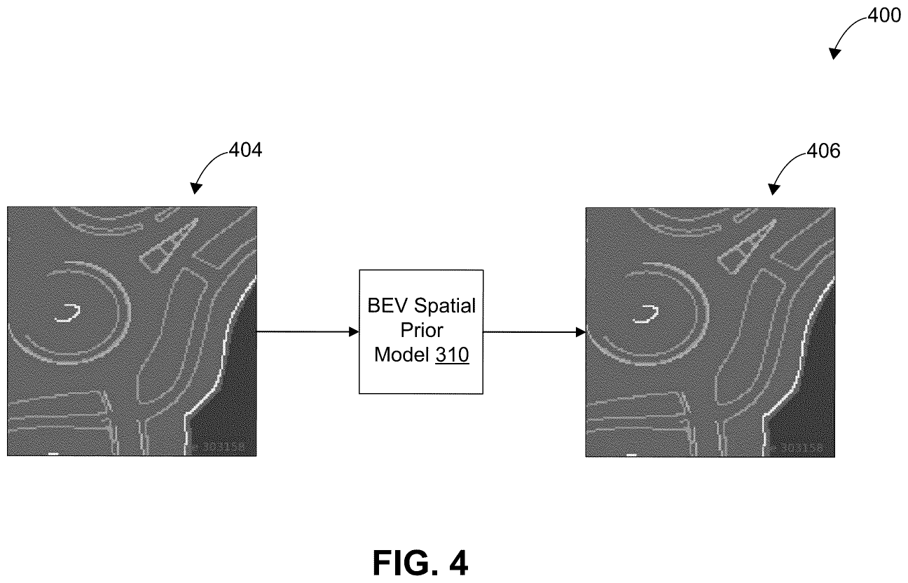

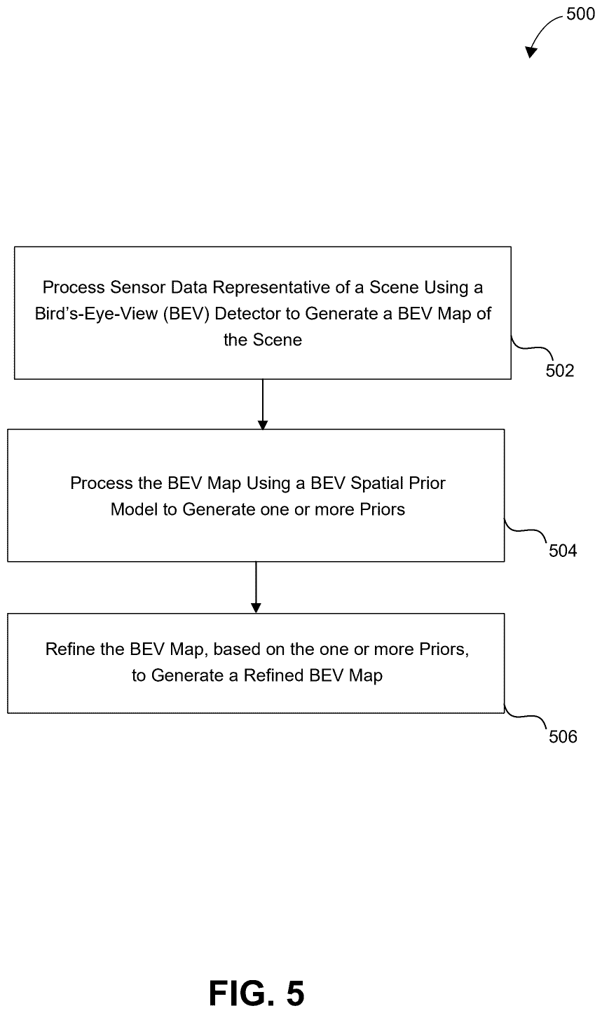

FIG. 3 is a block diagram illustrating a first example system (system 300) for generating map data (e.g., BEV maps). FIG. 4 is a block diagram illustrating a process 400 for training BEV spatial prior machine-learning model 310 of system 300 of FIG. 3. FIG. 5 is a flow diagram illustrating a first example process (process 500) for generating map data. Process 500 may be performed by system 300 of FIG. 3.

FIG. 3 is a block diagram illustrating an example system 300 for generating map data (e.g., BEV maps), according to various aspects of the present disclosure. In general, a BEV detector 304 may generate a predicted BEV map 306 based on sensor data 302. An enhancer 314 may iteratively use a BEV spatial prior machine-learning model 310 to generate priors to generate an enhanced BEV map 316 based on predicted BEV map 306.

Sensor data 302 may be the same as, or may be substantially similar to, sensor data 202 of FIG. 2. Similarly, BEV detector 304 may be the same as, may be substantially similar to, and/or may perform the same, or substantially the same, operations as BEV detector 204 of FIG. 2. Predicted BEV map 306 may be the same as, or may be substantially similar to, predicted BEV map 206 of FIG. 2

BEV spatial prior machine-learning model 310 may be, or may include, a generative likelihood-based machine-learning model. For example, BEV spatial prior machine-learning model 310 may be, or may include, a normalizing flow machine-learning model (e.g., as described by “Glow: Generative Flow with Invertible 1×1 convolutions” by Diederik P. Kingma and Prafulla Dhariwal, submitted Jul. 9, 2018, available at https://arxiv.org/abs/1807.03039). As another example, BEV spatial prior machine-learning model 310 may be, or may include, a variational autoencoder (e.g., as described by “Auto-Encoding Variational Bayes” by Diederik P. Kingma and Max Welling, submitted Dec. 20, 2013, available at https://arxiv.org/abs/1312.6114). As another example, BEV spatial prior machine-learning model 310 may be, or may include, an autoregressive machine-learning model (e.g., as described by “PixelCNN++: Improving the PixelCNN with Discretized Logistic Mixture Likelihood and Other Modifications” by Tim Salimans, Andrej Karpathy, Xi Chen, and Diederik P. Kingma, submitted Jan. 19, 2017, available at https://arxiv.org/abs/1701.05517).

BEV spatial prior machine-learning model 310 may generate a likelihood score for a given BEV map y. Enhancer 314 may use the likelihood score to find the map y that maximizes p_{detector}(y|q)+λ*pₚᵣᵢₒᵣ(y).

BEV spatial prior machine-learning model 310 may reflect spatial dependencies learned through training. BEV spatial prior machine-learning model 310 may be trained (e.g., through an unsupervised training process) based on ground-truth BEV maps. BEV spatial prior machine-learning model 310 may give BEV maps that are likely realistic a high probability score, for example, BEV maps that have similar spatial characteristics as the ground truth BEV maps used to train the BEV spatial prior. Additionally, BEV spatial prior machine-learning model 310 may give unrealistic BEV maps a low score.

Enhancer 314 may solve an optimization problem to generate enhanced BEV map 316. Predicted BEV map 306 may be, or may include, a rasterized prediction image map in the BEV view. For example, predicted BEV map 306 may be, or may include, a probability tensor q of size H×W×C, where H and W are the height and width of predicted BEV map 306 and C is the number of map element classes (e.g., road-object types). That is, C gives the probabilities of different map elements being present in different pixels in the BEV image given the input sensors. y may be of size H×W with discrete class values in each pixel.

Further p_{detector}(y|q)=gives the joint probability of a certain map y given q, by multiplying the selected class probabilities over the pixels.

$${p}_{detector} ( y \vert q ) = {\prod }_{h ∈ 1 … H , w ∈ 1 … W} {q}_{h , w , {y}_{h , w}}$$

where it is assumed that each pixel belongs to a single class.

Enhancer 314 may solve the optimization problem

$$\begin{matrix}max \\ y\end{matrix} {p}_{detector} ( y \vert q ) + λ {p}_{prior} ( y )$$

where y represents a given BEV map (e.g., predicted BEV map 306);
where q represents a probability tensor;
where pdetector(y|q) represents the joint probability of a certain map y given q;
where pprior(y) represents a likelihood that the given BEV map is accurate;
where λ is a hyperparameter that may be tuned.

Enhancer 314 may solve the optimization problem, for example, by freezing the network weights of BEV detector 304 and BEV spatial prior machine-learning model 310 and running a stochastic gradient descent to optimize with regard to y. The discrete variable y can be relaxed to be continuous in the optimization.

Using a small λ will put little weight on prior 312 and generate an output prediction map y (enhanced BEV map 316) that is similar to the input prediction (predicted BEV map 306). A high λ will put more weight on prior 312 and generate an output prediction map y (enhanced BEV map 316) that looks more realistic, but that still does not contradict the detector output probabilities q.

FIG. 4 is a block diagram illustrating a process 400 for training BEV spatial prior machine-learning model 310 of FIG. 3, according to various aspects of the present disclosure. BEV spatial prior machine-learning model 310 may be trained to learn spatial dependencies in ground truth BEV maps. For example, BEV spatial prior machine-learning model 310 may be trained through an unsupervised training process 400 to generate scores indicating a likelihood that input ground-truth BEV map 404 accurately reflect reality. For example, BEV spatial prior machine-learning model 310 may be trained using many ground-truth BEV maps 404.

FIG. 5 is a flow diagram illustrating an example process 500 for generating map data (e.g., a BEV map), in accordance with aspects of the present disclosure. One or more operations of process 500 may be performed by a computing device (or apparatus) or a component (e.g., a chipset, codec, etc.) of the computing device. The computing device may be a mobile device (e.g., a mobile phone), a network-connected wearable such as a watch, an extended reality (XR) device such as a virtual reality (VR) device or augmented reality (AR) device, a vehicle or component or system of a vehicle, a desktop computing device, a tablet computing device, a server computer, a robotic device, and/or any other computing device with the resource capabilities to perform the one or more operations of process 500. The one or more operations of process 500 may be implemented as software components that are executed and run on one or more processors. Process 500 may be performed by system 300 of FIG. 3.

At block 502, a computing device (or one or more components thereof) may process sensor data representative of a scene using a bird's-eye-view (BEV) detector to generate a BEV map of the scene. For example, BEV detector 304 may process sensor data 302 to generate predicted BEV map 306.

In some aspects, the sensor data comprises at least one of: image data; light detection and ranging (LIDAR) data; or radio detection and ranging (RADAR) data. For example, sensor data 302 may be, or may include, image data; LIDAR data; and/or RADAR data.

In some aspects, the BEV detector may be trained to generate BEV maps based on sensor data. For example, BEV detector 304 may be a machine-learning model trained to generate BEV maps based on sensor data.

In some aspects, to generate the BEV map, the BEV detector may: encode the sensor data to generate features; project the features into BEV space to generate projected features; and decode the projected features to generate the BEV map. For example, BEV detector 304 may encode sensor data 302 to generate features; project the features into BEV space to generate projected features; and decode the projected features to generate the BEV map.

In some aspects, the BEV map may be, or may include, a plurality of pixels. Each pixel of the plurality of pixels may be, or may include, a value indicative of a probability that the respective pixel represents a class. For example, predicted BEV map 306 may be, or may include, a plurality of pixels. Each pixel of the plurality of pixels of predicted BEV map 306 may be, or may include, a value indicative of a probability that the respective pixel represents a class.

In some aspects, the BEV map may be, or may include, a plurality of pixels. Each pixel of the plurality of pixels may be, or may include, a respective vector of values, and wherein a vector of values of a pixel of the plurality of pixels indicates probabilities that the pixel represents classes. For example, predicted BEV map 306 may be, or may include, a plurality of pixels. Each pixel of the plurality of pixels of predicted BEV map 306 may be, or may include, a respective vector of values, and wherein a vector of values of a pixel of the plurality of pixels indicates probabilities that the pixel represents classes.

At block 504, the computing device (or one or more components thereof) may process the BEV map using a BEV spatial prior model to generate one or more priors. For example, BEV spatial prior machine-learning model 310 may process predicted BEV map 306 to generate priors.

At block 506, the computing device (or one or more components thereof) may refine the BEV map, based on the one or more priors, to generate a refined BEV map. For example, enhancer 314 may refine predicted BEV map 306 based on the priors to generate enhanced BEV map 316.

In some aspects, the refined BEV map may be, or may include, a plurality of pixels. Each pixel of the plurality of pixels may be, or may include, a respective indication of a class. For example, enhanced BEV map 316 may be, or may include, a plurality of pixels. Each pixel of the plurality of pixels of enhanced BEV map 316 may be, or may include, a respective indication of a class.

In some aspects, the BEV spatial prior model may be, or may include, a generative likelihood-based machine-learning model. For example, BEV spatial prior machine-learning model 310 may be, or may include, a generative likelihood-based machine-learning model.

In some aspects, the BEV spatial prior model may be, or may include, at least one of: a normalizing flow machine-learning model; a variational autoencoder machine-learning model; or an autoregressive machine-learning model. For example, BEV spatial prior machine-learning model 310 may be, or may include, a normalizing flow machine-learning model; a variational autoencoder machine-learning model; and/or an autoregressive machine-learning model.

In some aspects, the BEV spatial prior model may be trained using an unsupervised training process based on ground-truth BEV maps. For example, BEV spatial prior machine-learning model 310 may be trained using an unsupervised training process based on ground-truth BEV maps.

In some aspects, to refine the BEV map, the computing device (or one or more components thereof) may optimize an objective including a detector probability and a prior probability to generate the refined BEV map. For example, enhancer 314 may optimize an objective including a detector probability and a prior probability to generate enhanced BEV map 316.

In some aspects, the detector probability may be based on the BEV map and the prior probability may be, or may include, one of the one or more priors generated by the BEV spatial prior model. For example, enhancer 314 may optimize an objective including a detector probability based on BEV map 306 and a prior probability based on one of the priors.

In some aspects, to optimize the objective, the computing device (or one or more components thereof) may solve an optimization problem based on the detector probability and the prior probability. For example, enhancer 314 may solve an optimization problem based on the detector probability and the prior probability.

In some aspects, the detector probability may be, or may include, a likelihood that the BEV map is accurate given probabilities determined by the BEV detector.

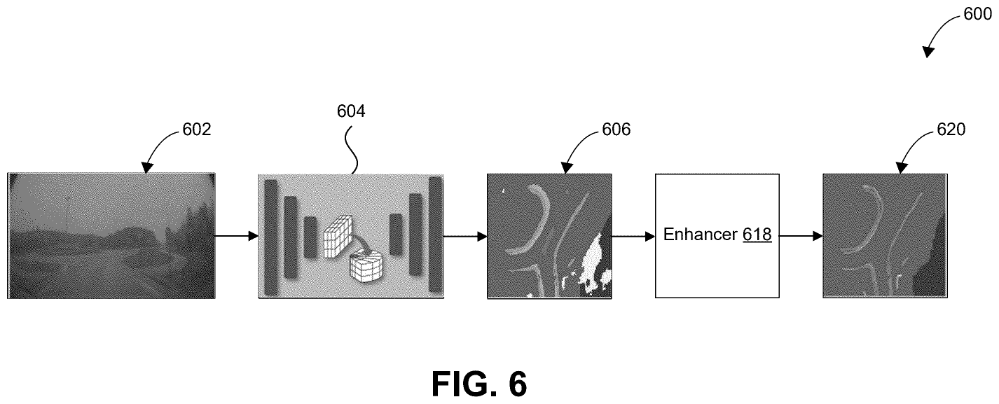

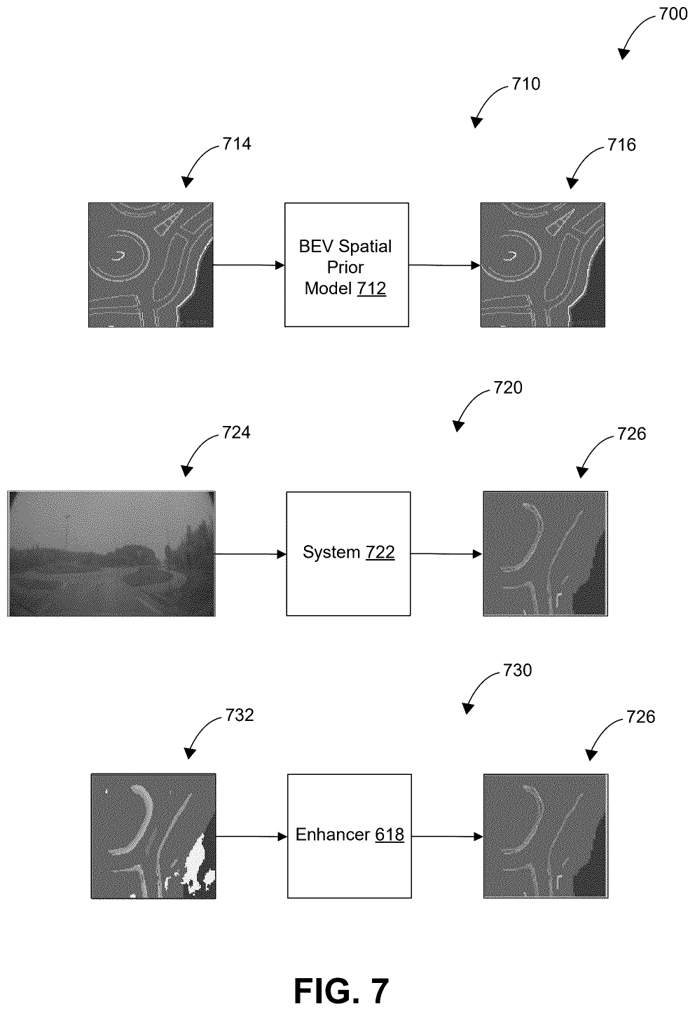

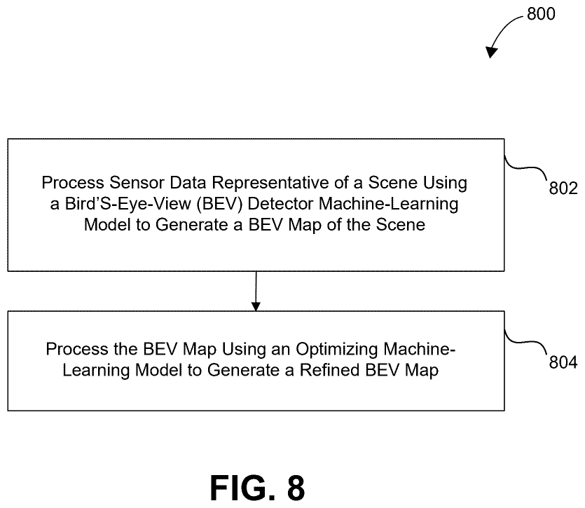

FIG. 6 is a block diagram illustrating a second example system (system 600) for generating map data. FIG. 7 is a block diagram illustrating a process 700 for training enhancer 618 of system 600 of FIG. 6. FIG. 8 is a flow diagram illustrating a second example process (process 800) for generating map data. Process 800 may be performed by system 600 of FIG. 6.

FIG. 6 is a block diagram illustrating an example system 600 for generating BEV maps, according to various aspects of the present disclosure. In general, a BEV detector 604 may generate a predicted BEV map 606 based on sensor data 602. An enhancer 618 may enhance predicted BEV map 606 to generate enhanced BEV map 620.

Sensor data 602 may be the same as, or may be substantially similar to, sensor data 202 of FIG. 2. Similarly, BEV detector 604 may be the same as, may be substantially similar to, and/or may perform the same, or substantially the same, operations as BEV detector 204 of FIG. 2. Further, predicted BEV map 606 may be the same as, or may be substantially similar to, predicted BEV map 206 of FIG. 2.

Enhancer 618 may be, or may include, a machine-learning model trained to enhance BEV maps. For example, enhancer 618 may be trained through an iterative back-propagation technique to cause BEV maps that are generated by a BEV NN to be more like BEV maps that have been enhanced according by system 300 of FIG. 3.

Comparing system 300 of FIG. 3 to system 600 of FIG. 6, enhancer 618 may approximate BEV spatial prior machine-learning model 310 and enhancer 314 of FIG. 3. Enhancer 618 may be trained by first collecting pairs of detector output probabilities q and solutions to the optimization problem y*, and then training enhancer 618 in a supervised manner using q as input and y* as output.

Alternatively, enhancer 618 can be trained to optimize the optimization objective

$$\begin{matrix}max \\ y\end{matrix} {p}_{detector} ( y \vert q ) + λ {p}_{prior} ( y )$$

directly, with q as input and y as output.

Enhancer 618 may replace BEV spatial prior machine-learning model 310 and enhancer 314 in system 300.

FIG. 7 is a block diagram illustrating a process 700 for training enhancer 618 of FIG. 6, according to various aspects of the present disclosure. Process 700 includes three stages, stage 710, stage 720, and stage 730.

In stage 710, a BEV spatial prior machine-learning model 712 may be trained. BEV spatial prior machine-learning model 712 may be the same as, may be substantially similar to, and/or may perform the same, or substantially the same, operations as BEV spatial prior machine-learning model 310 of FIG. 3. Stage 710 may be the same as process 400 of training BEV spatial prior machine-learning model 310. For example, BEV spatial prior machine-learning model 712 may be trained using an unsupervised training technique based on ground-truth BEV map 714 to generate an indication that a provided input is realistic.

In stage 720, BEV spatial prior machine-learning model 712 may produce a number of training enhanced BEV maps 726 based on input BEV maps and/or input training sensor data 724. For example, BEV spatial prior machine-learning model 712 may be used in a system 722 that is the same as, or substantially similar to, system 300 to produce a number of instances of training enhanced BEV map 726 based on a number of instances of training sensor data 724.

In stage 730, enhancer 618 may be trained, using a supervised training process, to cause input BEV maps to appear like training enhanced BEV map 726. For example, enhancer 618 may be provided with a number of instances of training predicted BEV maps 732, which may be generated by a BEV detector 304 based on sensor data 302. Enhancer 618 may generate output BEV maps based on the input BEV maps. The output BEV maps may be compared to training enhanced BEV map 726 (e.g., as generated in stage 720) and parameters of enhancer 618 may be adjusted such that in future iterations of stage 730, enhancer 618 may generate enhanced BEV maps that are similar to training enhanced BEV map 726.

FIG. 8 is a flow diagram illustrating an example process 800 for generating map data (e.g., a BEV map), in accordance with aspects of the present disclosure. One or more operations of process 800 may be performed by a computing device (or apparatus) or a component (e.g., a chipset, codec, etc.) of the computing device. The computing device may be a mobile device (e.g., a mobile phone), a network-connected wearable such as a watch, an extended reality (XR) device such as a virtual reality (VR) device or augmented reality (AR) device, a vehicle or component or system of a vehicle, a desktop computing device, a tablet computing device, a server computer, a robotic device, and/or any other computing device with the resource capabilities to perform the one or more operations of process 800. The one or more operations of process 800 may be implemented as software components that are executed and run on one or more processors. Process 800 may be performed by system 600 of FIG. 6.

At block 802, a computing device (or one or more components thereof) may process sensor data representative of a scene using a bird's-eye-view (BEV) detector to generate a BEV map of the scene. For example, BEV detector 604 may process sensor data 602 to generate predicted BEV map 606.

At block 804, the computing device (or one or more components thereof) may process the BEV map using an enhancer model to generate a refined BEV map. For example, enhancer 618 may process predicted BEV map 606 to generate enhanced BEV map 620.

In some aspects, the enhancer model is trained using a supervised training process to generate refined BEV maps based on BEV maps. For example, enhancer 618 may be trained using a supervised training process (e.g., process 700) to generate refined BEV maps based on BEV maps.

In some aspects, the refined BEV maps used in the supervised training process are generated by: processing the BEV maps using a BEV spatial prior model to generate one or more priors; and refining the BEV maps based on the BEV maps and the one or more priors to generate the refined BEV maps. For example, at stage 720, system 722 (which may include BEV spatial prior machine-learning model 712) may process training sensor data 724 to generate enhanced BEV map 726. At stage 730, enhancer 618 may be trained using enhanced BEV map 726 as ground truth.

In some aspects, the BEV spatial prior model comprises a generative likelihood-based machine-learning model. For example, BEV spatial prior machine-learning model 712 may be, or may include, a generative likelihood-based machine-learning model.

In some aspects, the BEV spatial prior model is trained using an unsupervised training process based on ground-truth BEV maps. For example, BEV spatial prior machine-learning model 712 may be trained at stage 710 using an unsupervised training process.

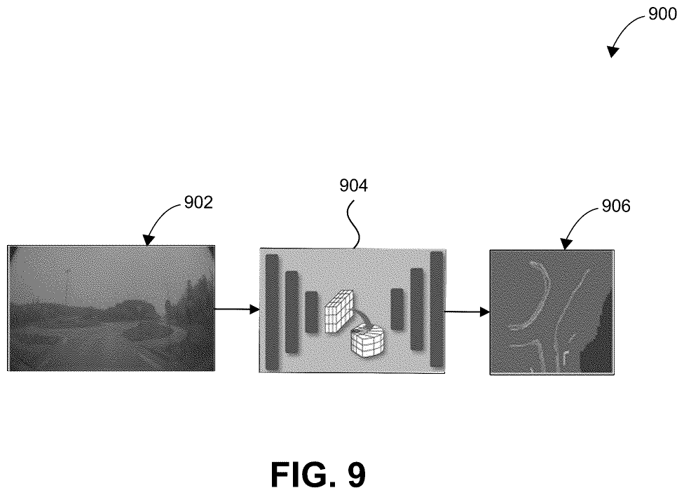

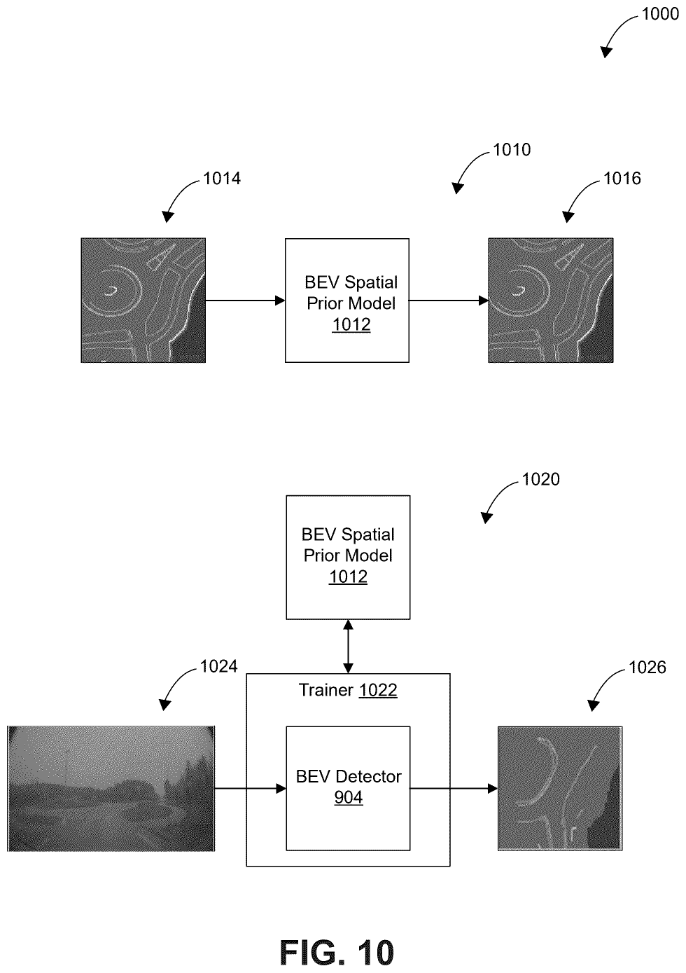

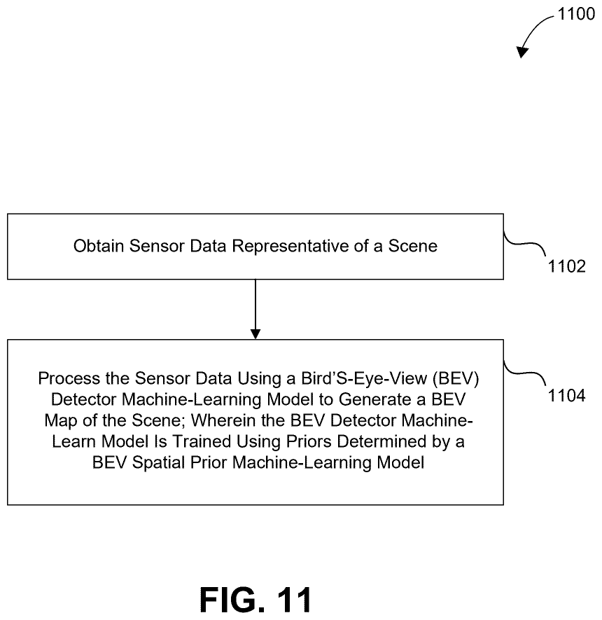

FIG. 9 is a block diagram illustrating a third example system (system 900) for generating map data. FIG. 10 is a block diagram illustrating a process 1000 for training BEV detector 904 of system 900 of FIG. 9. FIG. 11 is a flow diagram illustrating a third example process (process 1100) for generating map data. Process 1100 may be performed by system 900 of FIG. 9.

FIG. 9 is a block diagram illustrating an example system 900 for generating BEV maps, according to various aspects of the present disclosure. In general, a BEV detector 904 may generate a predicted BEV map 906 based on sensor data 902. BEV detector 904 may be trained using BEV spatial priors.

Sensor data 902 may be the same as, or may be substantially similar to, sensor data 202 of FIG. 2. Similarly, BEV detector 904 may be similar to BEV detector 204 of FIG. 2. Predicted BEV map 906 similar to predicted BEV map 206 of FIG. 2. However, BEV detector 904 may be trained differently than BEV detector 204 of FIG. 2. For example, BEV detector 904 may be trained using BEV spatial priors such that predicted BEV map 906 is more similar to enhanced BEV map 316 than predicted BEV map 906 is to predicted BEV map 306.

For example, instead of applying the BEV spatial prior as a postprocessing step (e.g., as described with regard to system 300), system 900 may use the prior as an additional loss function during training of BEV detector 904. To do this, the output probabilities q may be converted to class predictions y by applying a fixed confidence threshold and applying −log pprior(y) as the loss function.

FIG. 10 is a block diagram illustrating a process 1000 for training BEV detector 904 of FIG. 9, according to various aspects of the present disclosure. Process 1000 includes two stages, stage 1010 and stage 1020.

In stage 1010, a BEV spatial prior machine-learning model 1012 may be trained. BEV spatial prior machine-learning model 1012 may be the same as, may be substantially similar to, and/or may perform the same, or substantially the same, operations as BEV spatial prior machine-learning model 310 of FIG. 3. Stage 1010 may be the same as process 400 of training BEV spatial prior machine-learning model 310. For example, BEV spatial prior machine-learning model 1012 may be trained using an unsupervised training technique based on ground-truth BEV map 1014 to generate an indication that a provided input is realistic.

In stage 1020, trainer 1022 may train BEV detector 904 through a supervised training process. For example, trainer 1022 may provide BEV detector 904 with training sensor data 1024. BEV detector 904 may generate a provisional BEV map based on training sensor data 1024. Trainer 1022 may compare the provisional BEV map to a ground-truth BEV map corresponding to training sensor data 1024 to determine a loss (e.g., based on differences between the provisional BEV map generated by BEV detector 904 and the ground-truth BEV map). Additionally, trainer 1022 may provide the provisional BEV map to BEV spatial prior machine-learning model 1012 and BEV spatial prior machine-learning model 1012 may determine a prior (e.g., a likelihood that the provisional BEV map is accurate). Trainer 1022 may adjust parameters (e.g., weights) of BEV detector 904 based on determined losses such that in future iterations of the training process, BEV detector 904 produces BEV maps that are more similar to ground-truth BEV maps and that are more likely to be determined as accurate by BEV spatial prior machine-learning model 1012 according to an iterative gradient-descent training process.

FIG. 11 is a flow diagram illustrating an example process 1100 for generating map data (e.g., a BEV map), in accordance with aspects of the present disclosure. One or more operations of process 1100 may be performed by a computing device (or apparatus) or a component (e.g., a chipset, codec, etc.) of the computing device. The computing device may be a mobile device (e.g., a mobile phone), a network-connected wearable such as a watch, an extended reality (XR) device such as a virtual reality (VR) device or augmented reality (AR) device, a vehicle or component or system of a vehicle, a desktop computing device, a tablet computing device, a server computer, a robotic device, and/or any other computing device with the resource capabilities to perform the one or more operations of process 1100. The one or more operations of process 1100 may be implemented as software components that are executed and run on one or more processors. Process 1100 may be performed by system 900 of FIG. 9.

At block 1102, a computing device (or one or more components thereof) may obtain sensor data representative of a scene. For example, system 900 may obtain sensor data 902.

At block 1104, the computing device (or one or more components thereof) may process the sensor data using a bird's-eye-view (BEV) detector to generate a BEV map of the scene, wherein the BEV detector is trained using priors determined by a BEV spatial prior model. For example, BEV detector 904 may process sensor data 902 to generate predicted BEV map 906. BEV detector 904 may be trained using priors determined by a BEV spatial prior machine-learning model 1012.

In some aspects, the priors are used as a loss function in training the BEV detector. For example, at stage 1020, BEV detector 904 may be trained based on priors determined by BEV spatial prior machine-learning model 1012.

In some aspects, the BEV spatial prior model comprises a generative likelihood-based machine-learning model. For example, BEV spatial prior machine-learning model 1012 may be, or may include, a generative likelihood-based machine-learning model.

In some aspects, the BEV spatial prior model is trained using an unsupervised training process based on ground-truth BEV maps. For example, at stage 1010, BEV spatial prior machine-learning model 1012 may be trained using an unsupervised training process.

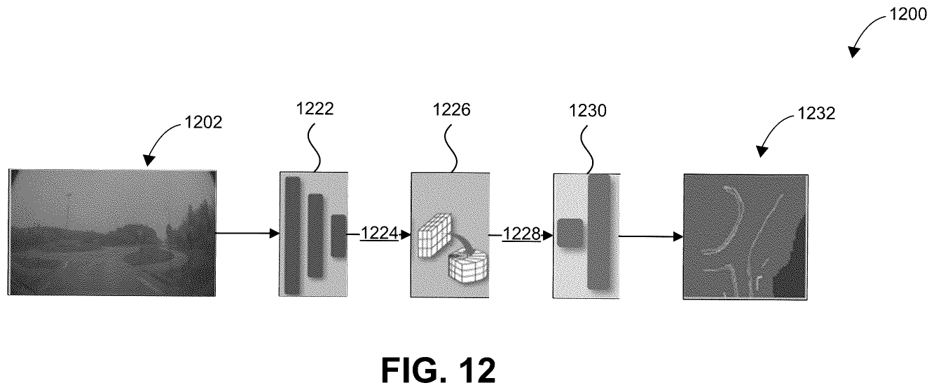

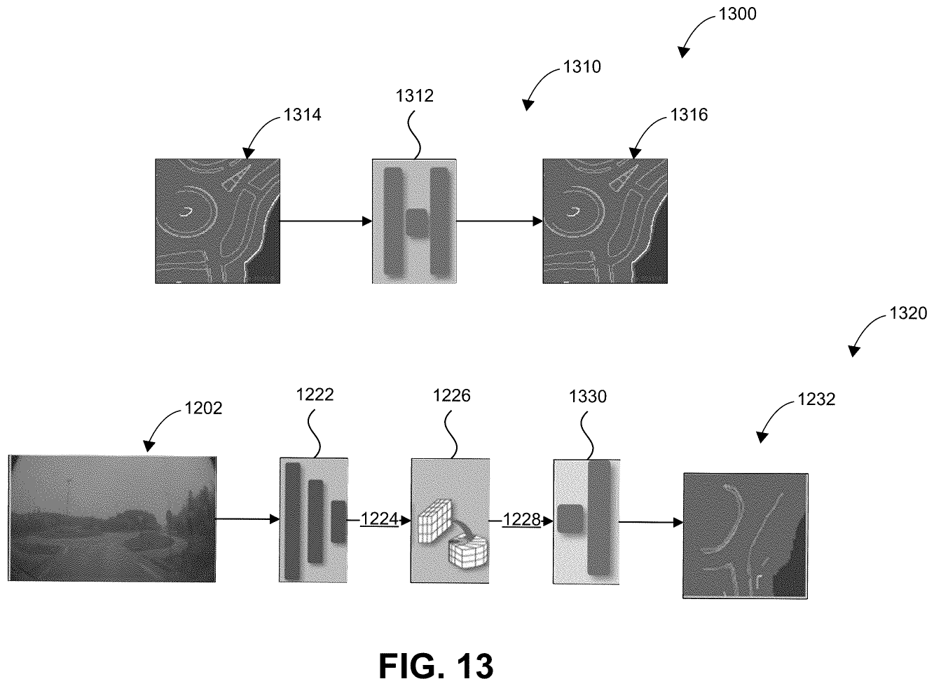

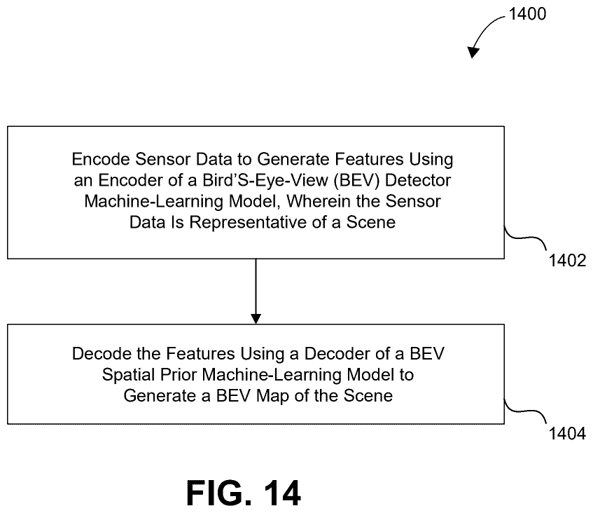

FIG. 12 is a block diagram illustrating a fourth example system (system 1200) for generating map data. FIG. 13 is a block diagram illustrating a process 1300 for training encoder 1222 and decoder 1230 of system 1200 of FIG. 12. FIG. 14 is a flow diagram illustrating a fourth example process (process 1400) for generating map data. Process 1400 may be performed by system 1200 of FIG. 12.

FIG. 12 is a block diagram illustrating an example system 1200 for generating BEV maps, according to various aspects of the present disclosure. In general, an encoder 1222 may encode sensor data 1202 to generate features 1224. A projector 1226 may project features 1224 from a sensor space to a BEV space to generate projected features 1228. A decoder 1230 may decode projected features 1228 to generate a predicted BEV map 1232.

Encoder 1222, projector 1226, and decoder 1230 may operate similar to BEV detector 204 of FIG. 2. However, whereas BEV detector 204 is trained as in an end-to-end training process as a combined encoder-decoder, encoder 1222, projector 1226, and decoder 1230 may be trained separately, as part of separate networks. For example, encoder 1222 may be an encoder portion of an encoder-decoder network (such as BEV detector 204). Decoder 1230 may be a decoder portion of an auto-encoder BEV spatial prior machine-learning model.

For example, a BEV spatial prior machine-learning model may be trained using ground truth BEV maps. The BEV spatial prior machine-learning model may be trained to compress the map y to a latent variable z that can also be used to reconstruct y. The decoder portion of the BEV spatial prior machine-learning model may be used during the training of encoder 1222 to train to predict z. At inference, the decoder portion of the BEV spatial prior machine-learning model may be used to construct y from z. The weights of the BEV spatial prior machine-learning model may be frozen so that gradients are propagated through to train the weights of encoder 1222.

FIG. 13 is a block diagram illustrating a process 1300 for training a BEV spatial prior machine-learning model 1312 and encoder 1222 of FIG. 12, according to various aspects of the present disclosure. Process 1300 includes two stages, stage 1310 and stage 1320.

In stage 1310 BEV spatial prior machine-learning model 1312 may be trained as an autoencoder (using an unsupervised training process) based on ground-truth BEV map 1314. For example, BEV spatial prior machine-learning model 1312 may be trained to encode ground-truth BEV map 1314 to a latent variable z then to decode the latent variable z to reconstruct, as closely as possible, the input ground-truth BEV map. The latent variable z may be smaller, in data size, than the input ground-truth BEV map (e.g., the latent variable may have fewer dimensions than the input ground-truth BEV map). For example, training BEV spatial prior machine-learning model 1312 as an auto-encoder may involve training BEV spatial prior machine-learning model 1312 to compress BEV maps and to decompress BEV maps.

In stage 1320, a decoder portion of BEV spatial prior machine-learning model 1312 (e.g., decoder 1330) may be frozen and used in system 1200 of FIG. 12. With decoder 1330 replacing decoder 1230, system 1200 may be trained in stage 1320.

FIG. 14 is a flow diagram illustrating an example process 1400 for generating map data (e.g., a BEV map), in accordance with aspects of the present disclosure. One or more operations of process 1400 may be performed by a computing device (or apparatus) or a component (e.g., a chipset, codec, etc.) of the computing device. The computing device may be a mobile device (e.g., a mobile phone), a network-connected wearable such as a watch, an extended reality (XR) device such as a virtual reality (VR) device or augmented reality (AR) device, a vehicle or component or system of a vehicle, a desktop computing device, a tablet computing device, a server computer, a robotic device, and/or any other computing device with the resource capabilities to perform the one or more operations of process 1400. The one or more operations of process 1400 may be implemented as software components that are executed and run on one or more processors. Process 1400 may be performed by system 1200 of FIG. 12.

At block 1402, a computing device (or one or more components thereof) may encode sensor data to generate features using an encoder of a bird's-eye-view (BEV) detector, wherein the sensor data is representative of a scene. For example, encoder 1222 may encoder sensor data 1202 to generate features 1224. Encoder 1222 may be an encoder of a BEV detector.

In some aspects, the computing device (or one or more components thereof) may project the features into BEV space. For example, projector 1226 may project features 1224 into a BEV space to generate may decode projected features 1228.

At block 1404, the computing device (or one or more components thereof) may decode the features using a decoder of a BEV spatial prior model to generate a BEV map of the scene. For example, decoder 1230 may decode projected features 1228. Decoder 1230 may be a decoder of a BEV spatial prior machine-learning model.

In some aspects, the BEV spatial prior model comprises an autoencoder. For example, the BEV spatial prior from which decoder 1230 was taken may be, or may include, an autoencoder.

In some aspects, the BEV spatial prior model is trained using an unsupervised training process based on ground-truth BEV maps. For example, at stage 1310, BEV spatial prior machine-learning model 1312 may trained using an unsupervised training process.

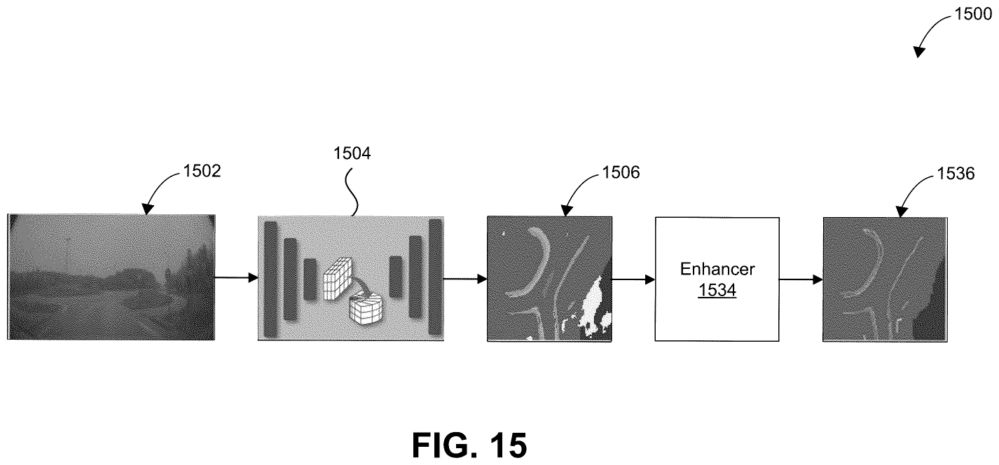

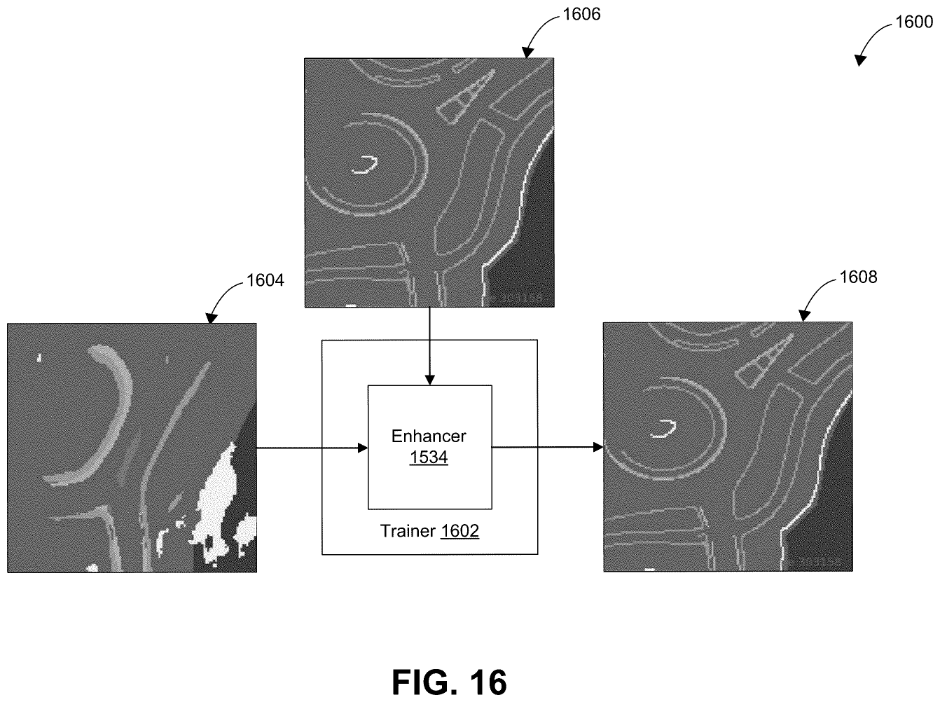

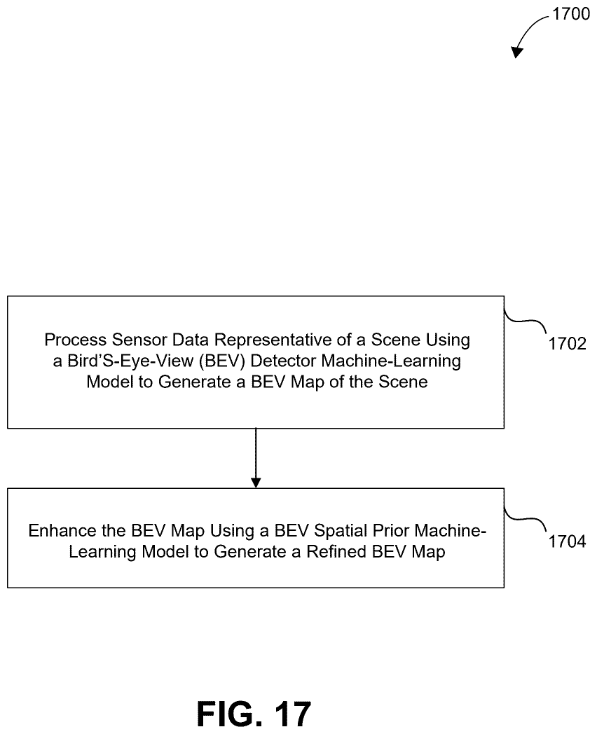

FIG. 15 is a block diagram illustrating a fifth example system (system 1500) for generating map data. FIG. 16 is a block diagram illustrating a process 1600 for training enhancer 1534 of system 1500 of FIG. 15. FIG. 17 is a flow diagram illustrating a fifth example process (process 1700) for generating map data. Process 1700 may be performed by system 1500 of FIG. 15.

FIG. 15 is a block diagram illustrating an example system 1500 for generating BEV maps, according to various aspects of the present disclosure. In general, a BEV detector 1504 may generate a predicted BEV map 1506 based on sensor data 1502. An enhancer 1534 may enhance predicted BEV map 1506 to generate enhanced BEV map 1536.

Sensor data 1502 may be the same as, or may be substantially similar to, sensor data 202 of FIG. 2. Similarly, BEV detector 1504 may be the same as, may be substantially similar to, and/or may perform the same, or substantially the same, operations as BEV detector 204 of FIG. 2. Further, predicted BEV map 1506 may be the same as, or may be substantially similar to, predicted BEV map 206 of FIG. 2.

Enhancer 1534 may be, or may include, a machine-learning model trained to enhance BEV maps. For example, enhancer 1534 may be trained through an iterative back-propagation technique to cause BEV maps that are generated by a BEV NN to be more like ground-truth BEV maps.

Comparing system 1500 of FIG. 15 to system 600 of FIG. 6, enhancer 1534 may be trained to cause enhanced BEV map 1536 to be like ground-truth BEV maps whereas enhancer 618 may be trained to cause enhanced BEV map 620 to be like enhanced BEV map 316.

Enhancer 1534 may be, or may include, a generative machine-learning model. For example, enhancer 1534 may be, or may include, a diffusion model (e.g., as described by “Denoising Diffusion Probabilistic Models” by Jonathan Ho, Ajay Jain, and Pieter Abbeel, submitted Jun. 19, 2020, available at https://arxiv.org/abs/2006.11239). As another example, enhancer 1534 may be, or may include, a generative adversarial network (GAN).

Enhancer 1534 may be trained conditioned on BEV detector output probabilities q as input and the ground truth map y as output. The BEV detector could be pretrained and frozen, or trained jointly with enhancer 1534.

FIG. 16 is a block diagram illustrating a process 1600 for training enhancer 1534 of FIG. 15, according to various aspects of the present disclosure. Enhancer 1534 may be trained to generate realistic BEV maps from BEV maps generated by a BEV detector.

For example, a trainer 1602 may provide enhancer 1534 with a training BEV map 1604. Training BEV map 1604 may be generated by a BEV detector (such as BEV detector 204 of FIG. 2). Enhancer 1534 may generate a provisional output BEV map 1608 based on training BEV map 1604. Trainer 1602 may compare the provisional output BEV map 1608 to a ground-truth BEV map 1606 and determine a loss between ground-truth BEV map 1606 and output BEV map 1608. Trainer 1602 may adjust parameters (e.g., weights) of enhancer 1534 to decrease further losses of further iterations of the iterative training processed according to a gradient-descent technique. In other words, trainer 1602 may adjust parameters of enhancer 1534 such that in further iterations of the training process, further instances of output BEV map 1608 are more similar to corresponding instances of ground-truth BEV map 1606.

FIG. 17 is a flow diagram illustrating an example process 1700 for generating map data (e.g., a BEV map), in accordance with aspects of the present disclosure. One or more operations of process 1700 may be performed by a computing device (or apparatus) or a component (e.g., a chipset, codec, etc.) of the computing device. The computing device may be a mobile device (e.g., a mobile phone), a network-connected wearable such as a watch, an extended reality (XR) device such as a virtual reality (VR) device or augmented reality (AR) device, a vehicle or component or system of a vehicle, a desktop computing device, a tablet computing device, a server computer, a robotic device, and/or any other computing device with the resource capabilities to perform the one or more operations of process 1700. The one or more operations of process 1700 may be implemented as software components that are executed and run on one or more processors. Process 1700 may be performed by system 1500 of FIG. 15.

At block 1702, a computing device (or one or more components thereof) may process sensor data representative of a scene using a bird's-eye-view (BEV) detector to generate a BEV map of the scene. For example, BEV detector 1504 may process sensor data 1502 to generate predicted BEV map 1506.

At block 1704, the computing device (or one or more components thereof) may enhance the BEV map using a BEV spatial prior model to generate a refined BEV map. For example, enhancer 1534 may process predicted BEV map 1506 to generate enhanced BEV map 1536.

In some aspects, the BEV spatial prior model is trained using a supervised training process based on BEV maps and ground-truth BEV maps. For example, enhancer 1534 may be trained according to process 1600.

In some aspects, the BEV spatial prior model comprises a generative machine-learning model. For example, enhancer 1534 may be a generative machine-learning model.

In some aspects, the BEV spatial prior model may be, or may include, at least one of: a diffusion model; or a generative adversarial network (GAN). For example, enhancer 1534 may be, or may include, a diffusion model or a GAN.

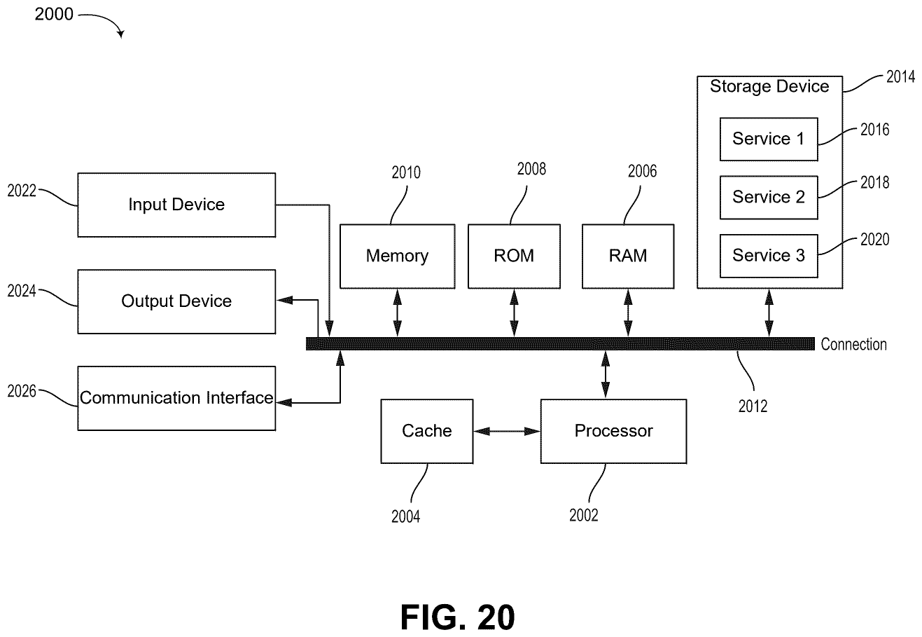

In some examples, as noted previously, the methods described herein (e.g., process 400 of FIG. 4, process 500 of FIG. 5, process 700 of FIG. 7, process 800 of FIG. 8, process 1000 of FIG. 10, process 1100 of FIG. 11, process 1300 of FIG. 13, process 1400 of FIG. 14, process 1600 of FIG. 16, process 1700 of FIG. 17 and/or other methods described herein) can be performed, in whole or in part, by a computing device or apparatus. In one example, one or more of the methods can be performed by system 300 of FIG. 3, system 600 of FIG. 6, system 900 of FIG. 9, system 1200 of FIG. 12, system 1500 of FIG. 15, or by another system or device. In another example, one or more of the methods (e.g., process 400, process 500, process 700, process 800, process 1000, process 1100, process 1300, process 1400, process 1600, process 1700, and/or other methods described herein) can be performed, in whole or in part, by the computing-device architecture 2000 shown in FIG. 20. For instance, a computing device with the computing-device architecture 2000 shown in FIG. 20 can include, or be included in, the components of the system 300, system 600, system 900, system 1200, and/or system 1500, and can implement the operations of process 400, process 500, process 700, process 800, process 1000, process 1100, process 1300, process 1400, process 1600, process 1700, and/or other process described herein. In some cases, the computing device or apparatus can include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device can include a display, a network interface configured to communicate and/or receive the data, any combination thereof, and/or other component(s). The network interface can be configured to communicate and/or receive Internet Protocol (IP) based data or other type of data.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

Process 400, process 500, process 700, process 800, process 1000, process 1100, process 1300, process 1400, process 1600, process 1700, and/or other process described herein are illustrated as logical flow diagrams, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, process 400, process 500, process 700, process 800, process 1000, process 1100, process 1300, process 1400, process 1600, process 1700, and/or other process described herein can be performed under the control of one or more computer systems configured with executable instructions and can be implemented as code (e.g., executable instructions, one or more computer programs, or one or more applications) executing collectively on one or more processors, by hardware, or combinations thereof. As noted above, the code can be stored on a computer-readable or machine-readable storage medium, for example, in the form of a computer program comprising a plurality of instructions executable by one or more processors. The computer-readable or machine-readable storage medium can be non-transitory.

As noted above, various aspects of the present disclosure can use machine-learning models or systems.

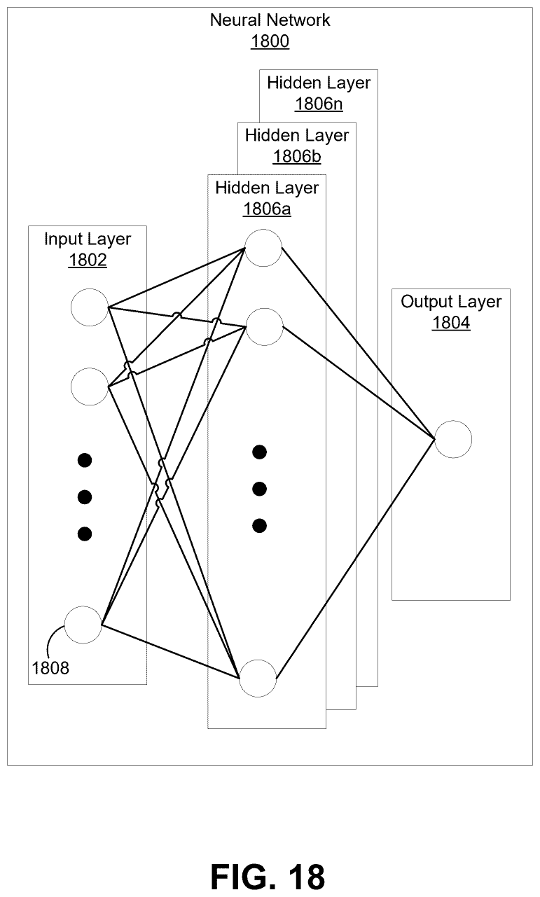

FIG. 18 is an illustrative example of a neural network 1800 (e.g., a deep-learning neural network) that can be used to implement machine-learning based feature segmentation, implicit-neural-representation generation, rendering, classification, object detection, image recognition (e.g., face recognition, object recognition, scene recognition, etc.), feature extraction, authentication, gaze detection, gaze prediction, likelihood prediction, BEV enhancement, BEV generation, encoding, decoding, auto-encoding, and/or automation. For example, neural network 1800 may be an example of, or can implement, BEV detector 304 of FIG. 3, BEV spatial prior machine-learning model 310 of FIG. 3 and FIG. 4, BEV detector 604 of FIG. 6, enhancer 618 of FIG. 6, BEV spatial prior machine-learning model 712 of FIG. 7, BEV detector 904 of FIG. 9 and FIG. 10, BEV spatial prior machine-learning model 1012 of FIG. 10, encoder 1222 of FIG. 12 and FIG. 13, decoder 1230 of FIG. 12, BEV spatial prior machine-learning model 1312 of FIG. 13, decoder 1322 of FIG. 13, BEV detector 1504 of FIG. 15, enhancer 1534 of FIG. 15 and FIG. 16.

An input layer 1802 includes input data. In one illustrative example, input layer 1802 can include data representing sensor data (such as image data, LIDAR data and/or RADAR data), for example, sensor data 202 of FIG. 2, sensor data 302, of FIG. 3, sensor data 602 of FIG. 6, training sensor data 724 of FIG. 7, sensor data 902 of FIG. 9, training sensor data 1024 of FIG. 10, sensor data 1202 of FIG. 12, training sensor data 1334 of FIG. 13, and/or sensor data 1502 of FIG. 15, and/or BEV maps, for example, predicted BEV map 306 of FIG. 3, ground-truth BEV map 404 of FIG. 4, predicted BEV map 606 of FIG. 6, ground-truth BEV map 714 of FIG. 7, training predicted BEV map 732 of FIG. 7, ground-truth BEV map 1014 of FIG. 10, ground-truth BEV map 1314 of FIG. 13, training BEV maps 1324 of FIG. 13, predicted BEV map 1506 of FIG. 15, training BEV map 1604 of FIG. 16.

Neural network 1800 includes multiple hidden layers, for example, hidden layers 1806a, 1806b, through 1806n. The hidden layers 1806a, 1806b, through hidden layer 1806n include “n” number of hidden layers, where “n” is an integer greater than or equal to one. The number of hidden layers can be made to include as many layers as needed for the given application. Neural network 1800 further includes an output layer 1804 that provides an output resulting from the processing performed by the hidden layers 1806a, 1806b, through 1806n. In one illustrative example, output layer 1804 can provide prior 312 of FIG. 3, output BEV map 406 of FIG. 4, enhanced BEV map 620 of FIG. 6, output BEV map 716 of FIG. 7, training enhanced BEV map 726 of FIG. 7, predicted BEV map 906 of FIG. 9, output BEV map 1016 of FIG. 10, training enhanced BEV map 1026 of FIG. 10, features 1224 of FIG. 12, predicted BEV map 1232 of FIG. 12, output BEV map 1316 of FIG. 13, latent variables 1326 of FIG. 13, latent variable 1336 of FIG. 13, enhanced BEV map 1536 of FIG. 15, and/or output BEV map 1608 of FIG. 16.

Neural network 1800 may be, or may include, a multi-layer neural network of interconnected nodes. Each node can represent a piece of information. Information associated with the nodes is shared among the different layers and each layer retains information as information is processed. In some cases, neural network 1800 can include a feed-forward network, in which case there are no feedback connections where outputs of the network are fed back into itself. In some cases, neural network 1800 can include a recurrent neural network, which can have loops that allow information to be carried across nodes while reading in input.

Information can be exchanged between nodes through node-to-node interconnections between the various layers. Nodes of input layer 1802 can activate a set of nodes in the first hidden layer 1806a. For example, as shown, each of the input nodes of input layer 1802 is connected to each of the nodes of the first hidden layer 1806a. The nodes of first hidden layer 1806a can transform the information of each input node by applying activation functions to the input node information. The information derived from the transformation can then be passed to and can activate the nodes of the next hidden layer 1806b, which can perform their own designated functions. Example functions include convolutional, up-sampling, data transformation, and/or any other suitable functions. The output of the hidden layer 1806b can then activate nodes of the next hidden layer, and so on. The output of the last hidden layer 1806n can activate one or more nodes of the output layer 1804, at which an output is provided. In some cases, while nodes (e.g., node 1808) in neural network 1800 are shown as having multiple output lines, a node has a single output and all lines shown as being output from a node represent the same output value.

In some cases, each node or interconnection between nodes can have a weight that is a set of parameters derived from the training of neural network 1800. Once neural network 1800 is trained, it can be referred to as a trained neural network, which can be used to perform one or more operations. For example, an interconnection between nodes can represent a piece of information learned about the interconnected nodes. The interconnection can have a tunable numeric weight that can be tuned (e.g., based on a training dataset), allowing neural network 1800 to be adaptive to inputs and able to learn as more and more data is processed.

Neural network 1800 may be pre-trained to process the features from the data in the input layer 1802 using the different hidden layers 1806a, 1806b, through 1806n in order to provide the output through the output layer 1804. In an example in which neural network 1800 is used to identify features in images, neural network 1800 can be trained using training data that includes both images and labels, as described above. For instance, training images can be input into the network, with each training image having a label indicating the features in the images (for the feature-segmentation machine-learning system) or a label indicating classes of an activity in each image. In one example using object classification for illustrative purposes, a training image can include an image of a number 2, in which case the label for the image can be [0 0 1 0 0 0 0 0 0 0].

In some cases, neural network 1800 can adjust the weights of the nodes using a training process called backpropagation. As noted above, a backpropagation process can include a forward pass, a loss function, a backward pass, and a weight update. The forward pass, loss function, backward pass, and parameter update are performed for one training iteration. The process can be repeated for a certain number of iterations for each set of training images until neural network 1800 is trained well enough so that the weights of the layers are accurately tuned.

For the example of identifying objects in images, the forward pass can include passing a training image through neural network 1800. The weights are initially randomized before neural network 1800 is trained. As an illustrative example, an image can include an array of numbers representing the pixels of the image. Each number in the array can include a value from 0 to 255 describing the pixel intensity at that position in the array. In one example, the array can include a 28×28×3 array of numbers with 28 rows and 28 columns of pixels and 3 color components (such as red, green, and blue, or luma and two chroma components, or the like).

As noted above, for a first training iteration for neural network 1800, the output will likely include values that do not give preference to any particular class due to the weights being randomly selected at initialization. For example, if the output is a vector with probabilities that the object includes different classes, the probability value for each of the different classes can be equal or at least very similar (e.g., for ten possible classes, each class can have a probability value of 0.1). With the initial weights, neural network 1800 is unable to determine low-level features and thus cannot make an accurate determination of what the classification of the object might be. A loss function can be used to analyze error in the output. Any suitable loss function definition can be used, such as a cross-entropy loss. Another example of a loss function includes the mean squared error (MSE), defined as Etotal=Σ ½ (target−output)2. The loss can be set to be equal to the value of Etotal.

The loss (or error) will be high for the first training images since the actual values will be much different than the predicted output. The goal of training is to minimize the amount of loss so that the predicted output is the same as the training label. Neural network 1800 can perform a backward pass by determining which inputs (weights) most contributed to the loss of the network and can adjust the weights so that the loss decreases and is eventually minimized. A derivative of the loss with respect to the weights (denoted as dL/dW, where W are the weights at a particular layer) can be computed to determine the weights that contributed most to the loss of the network. After the derivative is computed, a weight update can be performed by updating all the weights of the filters. For example, the weights can be updated so that they change in the opposite direction of the gradient. The weight update can be denoted as w=wi−ηdL/dW, where w denotes a weight, wi denotes the initial weight, and η denotes a learning rate. The learning rate can be set to any suitable value, with a high learning rate including larger weight updates and a lower value indicating smaller weight updates.

Neural network 1800 can include any suitable deep network. One example includes a convolutional neural network (CNN), which includes an input layer and an output layer, with multiple hidden layers between the input and out layers. The hidden layers of a CNN include a series of convolutional, nonlinear, pooling (for downsampling), and fully connected layers. Neural network 1800 can include any other deep network other than a CNN, such as an autoencoder, a deep belief nets (DBNs), a Recurrent Neural Networks (RNNs), among others.

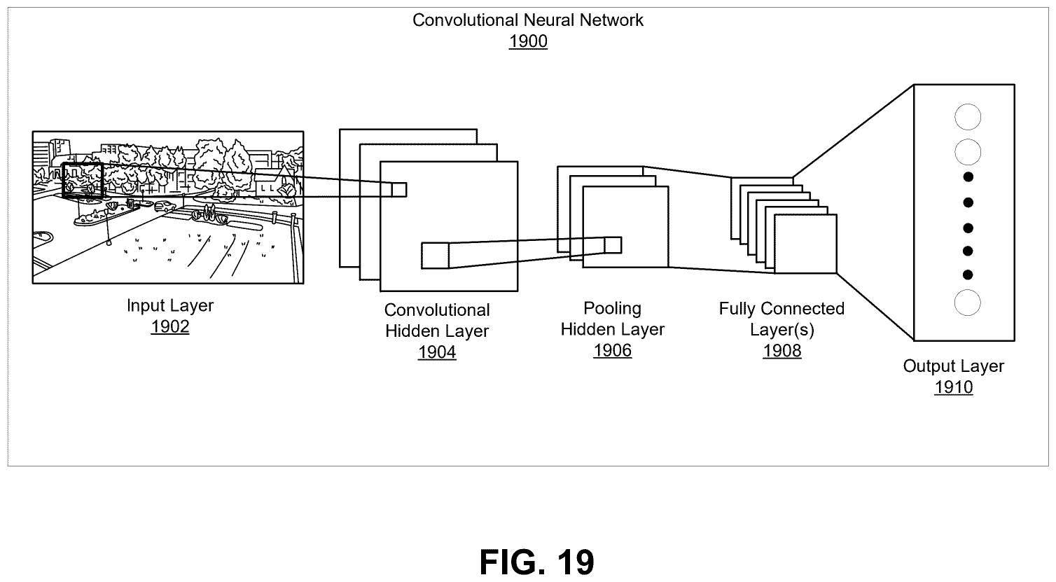

FIG. 19 is an illustrative example of a convolutional neural network (CNN) 1900. The input layer 1902 of the CNN 1900 includes data representing an image or frame. For example, the data can include an array of numbers representing the pixels of the image, with each number in the array including a value from 0 to 255 describing the pixel intensity at that position in the array. Using the previous example from above, the array can include a 28×28×3 array of numbers with 28 rows and 28 columns of pixels and 3 color components (e.g., red, green, and blue, or luma and two chroma components, or the like). The image can be passed through a convolutional hidden layer 1904, an optional non-linear activation layer, a pooling hidden layer 1906, and fully connected layer 1908 (which fully connected layer 1908 can be hidden) to get an output at the output layer 1910. While only one of each hidden layer is shown in FIG. 19, one of ordinary skill will appreciate that multiple convolutional hidden layers, non-linear layers, pooling hidden layers, and/or fully connected layers can be included in the CNN 1900. As previously described, the output can indicate a single class of an object or can include a probability of classes that best describe the object in the image.

The first layer of the CNN 1900 can be the convolutional hidden layer 1904. The convolutional hidden layer 1904 can analyze image data of the input layer 1902. Each node of the convolutional hidden layer 1904 is connected to a region of nodes (pixels) of the input image called a receptive field. The convolutional hidden layer 1904 can be considered as one or more filters (each filter corresponding to a different activation or feature map), with each convolutional iteration of a filter being a node or neuron of the convolutional hidden layer 1904. For example, the region of the input image that a filter covers at each convolutional iteration would be the receptive field for the filter. In one illustrative example, if the input image includes a 28×28 array, and each filter (and corresponding receptive field) is a 5×5 array, then there will be 24×24 nodes in the convolutional hidden layer 1904. Each connection between a node and a receptive field for that node learns a weight and, in some cases, an overall bias such that each node learns to analyze its particular local receptive field in the input image. Each node of the convolutional hidden layer 1904 will have the same weights and bias (called a shared weight and a shared bias). For example, the filter has an array of weights (numbers) and the same depth as the input. A filter will have a depth of 3 for an image frame example (according to three color components of the input image). An illustrative example size of the filter array is 5×5×3, corresponding to a size of the receptive field of a node.

The convolutional nature of the convolutional hidden layer 1904 is due to each node of the convolutional layer being applied to its corresponding receptive field. For example, a filter of the convolutional hidden layer 1904 can begin in the top-left corner of the input image array and can convolve around the input image. As noted above, each convolutional iteration of the filter can be considered a node or neuron of the convolutional hidden layer 1904. At each convolutional iteration, the values of the filter are multiplied with a corresponding number of the original pixel values of the image (e.g., the 5×5 filter array is multiplied by a 5×5 array of input pixel values at the top-left corner of the input image array). The multiplications from each convolutional iteration can be summed together to obtain a total sum for that iteration or node. The process is next continued at a next location in the input image according to the receptive field of a next node in the convolutional hidden layer 1904. For example, a filter can be moved by a step amount (referred to as a stride) to the next receptive field. The stride can be set to 1 or any other suitable amount. For example, if the stride is set to 1, the filter will be moved to the right by 1 pixel at each convolutional iteration. Processing the filter at each unique location of the input volume produces a number representing the filter results for that location, resulting in a total sum value being determined for each node of the convolutional hidden layer 1904.

The mapping from the input layer to the convolutional hidden layer 1904 is referred to as an activation map (or feature map). The activation map includes a value for each node representing the filter results at each location of the input volume. The activation map can include an array that includes the various total sum values resulting from each iteration of the filter on the input volume. For example, the activation map will include a 24×24 array if a 5×5 filter is applied to each pixel (a stride of 1) of a 28×28 input image. The convolutional hidden layer 1904 can include several activation maps in order to identify multiple features in an image. The example shown in FIG. 19 includes three activation maps. Using three activation maps, the convolutional hidden layer 1904 can detect three different kinds of features, with each feature being detectable across the entire image.

In some examples, a non-linear hidden layer can be applied after the convolutional hidden layer 1904. The non-linear layer can be used to introduce non-linearity to a system that has been computing linear operations. One illustrative example of a non-linear layer is a rectified linear unit (ReLU) layer. A ReLU layer can apply the function f(x)=max(0, x) to all of the values in the input volume, which changes all the negative activations to 0. The ReLU can thus increase the non-linear properties of the CNN 1900 without affecting the receptive fields of the convolutional hidden layer 1904.

The pooling hidden layer 1906 can be applied after the convolutional hidden layer 1904 (and after the non-linear hidden layer when used). The pooling hidden layer 1906 is used to simplify the information in the output from the convolutional hidden layer 1904. For example, the pooling hidden layer 1906 can take each activation map output from the convolutional hidden layer 1904 and generates a condensed activation map (or feature map) using a pooling function. Max-pooling is one example of a function performed by a pooling hidden layer. Other forms of pooling functions be used by the pooling hidden layer 1906, such as average pooling, L2-norm pooling, or other suitable pooling functions. A pooling function (e.g., a max-pooling filter, an L2-norm filter, or other suitable pooling filter) is applied to each activation map included in the convolutional hidden layer 1904. In the example shown in FIG. 19, three pooling filters are used for the three activation maps in the convolutional hidden layer 1904.

In some examples, max-pooling can be used by applying a max-pooling filter (e.g., having a size of 2×2) with a stride (e.g., equal to a dimension of the filter, such as a stride of 2) to an activation map output from the convolutional hidden layer 1904. The output from a max-pooling filter includes the maximum number in every sub-region that the filter convolves around. Using a 2×2 filter as an example, each unit in the pooling layer can summarize a region of 2×2 nodes in the previous layer (with each node being a value in the activation map). For example, four values (nodes) in an activation map will be analyzed by a 2×2 max-pooling filter at each iteration of the filter, with the maximum value from the four values being output as the “max” value. If such a max-pooling filter is applied to an activation filter from the convolutional hidden layer 1904 having a dimension of 24×24 nodes, the output from the pooling hidden layer 1906 will bean array of 12×12 nodes.

In some examples, an L2-norm pooling filter could also be used. The L2-norm pooling filter includes computing the square root of the sum of the squares of the values in the 2×2 region (or other suitable region) of an activation map (instead of computing the maximum values as is done in max-pooling) and using the computed values as an output.

The pooling function (e.g., max-pooling, L2-norm pooling, or other pooling function) determines whether a given feature is found anywhere in a region of the image and discards the exact positional information. This can be done without affecting results of the feature detection because, once a feature has been found, the exact location of the feature is not as important as its approximate location relative to other features. Max-pooling (as well as other pooling methods) offer the benefit that there are many fewer pooled features, thus reducing the number of parameters needed in later layers of the CNN 1900.

The final layer of connections in the network is a fully-connected layer that connects every node from the pooling hidden layer 1906 to every one of the output nodes in the output layer 1910. Using the example above, the input layer includes 28×28 nodes encoding the pixel intensities of the input image, the convolutional hidden layer 1904 includes 3×24×24 hidden feature nodes based on application of a 5×5 local receptive field (for the filters) to three activation maps, and the pooling hidden layer 1906 includes a layer of 3×12×12 hidden feature nodes based on application of max-pooling filter to 2×2 regions across each of the three feature maps. Extending this example, the output layer 1910 can include ten output nodes. In such an example, every node of the 3×12×12 pooling hidden layer 1906 is connected to every node of the output layer 1910.

The fully connected layer 1908 can obtain the output of the previous pooling hidden layer 1906 (which should represent the activation maps of high-level features) and determines the features that most correlate to a particular class. For example, the fully connected layer 1908 can determine the high-level features that most strongly correlate to a particular class and can include weights (nodes) for the high-level features. A product can be computed between the weights of the fully connected layer 1908 and the pooling hidden layer 1906 to obtain probabilities for the different classes. For example, if the CNN 1900 is being used to predict that an object in an image is a person, high values will be present in the activation maps that represent high-level features of people (e.g., two legs are present, a face is present at the top of the object, two eyes are present at the top left and top right of the face, a nose is present in the middle of the face, a mouth is present at the bottom of the face, and/or other features common for a person).

In some examples, the output from the output layer 1910 can include an M-dimensional vector (in the prior example, M=10). M indicates the number of classes that the CNN 1900 has to choose from when classifying the object in the image. Other example outputs can also be provided. Each number in the M-dimensional vector can represent the probability the object is of a certain class. In one illustrative example, if a 10-dimensional output vector represents ten different classes of objects is [0 0 0.05 0.8 0 0.15 0 0 0 0], the vector indicates that there is a 5% probability that the image is the third class of object (e.g., a dog), an 80% probability that the image is the fourth class of object (e.g., a human), and a 15% probability that the image is the sixth class of object (e.g., a kangaroo). The probability for a class can be considered a confidence level that the object is part of that class.

FIG. 20 illustrates an example computing-device architecture 2000 of an example computing device which can implement the various techniques described herein. In some examples, the computing device can include a mobile device, a wearable device, an extended reality device (e.g., a virtual reality (VR) device, an augmented reality (AR) device, or a mixed reality (MR) device), a personal computer, a laptop computer, a video server, a vehicle (or computing device of a vehicle), or other device. For example, the computing-device architecture 2000 may include, implement, or be included in any or all of system 300 of FIG. 3, system 600 of FIG. 6, system 900 of FIG. 9, system 1200 of FIG. 12, system 1500 of FIG. 15 and/or other devices, modules, or systems described herein. Additionally or alternatively, computing-device architecture 2000 may be configured to perform process 400 of FIG. 4, process 500 of FIG. 5, process 700 of FIG. 7, process 800 of FIG. 8, process 1000 of FIG. 10, process 1100 of FIG. 11, process 1300 of FIG. 13, process 1400 of FIG. 14, process 1600 of FIG. 16, process 1700 of FIG. 17, and/or other process described herein.

The components of computing-device architecture 2000 are shown in electrical communication with each other using connection 2012, such as a bus. The example computing-device architecture 2000 includes a processing unit (CPU or processor) 2002 and computing device connection 2012 that couples various computing device components including computing device memory 2010, such as read only memory (ROM) 2008 and random-access memory (RAM) 2006, to processor 2002.

Computing-device architecture 2000 can include a cache of high-speed memory connected directly with, in close proximity to, or integrated as part of processor 2002. Computing-device architecture 2000 can copy data from memory 2010 and/or the storage device 2014 to cache 2004 for quick access by processor 2002. In this way, the cache can provide a performance boost that avoids processor 2002 delays while waiting for data. These and other modules can control or be configured to control processor 2002 to perform various actions. Other computing device memory 2010 may be available for use as well. Memory 2010 can include multiple different types of memory with different performance characteristics. Processor 2002 can include any general-purpose processor and a hardware or software service, such as service 1 2016, service 2 2018, and service 3 2020 stored in storage device 2014, configured to control processor 2002 as well as a special-purpose processor where software instructions are incorporated into the processor design. Processor 2002 may be a self-contained system, containing multiple cores or processors, a bus, memory controller, cache, etc. A multi-core processor may be symmetric or asymmetric.

To enable user interaction with the computing-device architecture 2000, input device 2022 can represent any number of input mechanisms, such as a microphone for speech, a touch-sensitive screen for gesture or graphical input, keyboard, mouse, motion input, speech and so forth. Output device 2024 can also be one or more of a number of output mechanisms known to those of skill in the art, such as a display, projector, television, speaker device, etc. In some instances, multimodal computing devices can enable a user to provide multiple types of input to communicate with computing-device architecture 2000. Communication interface 2026 can generally govern and manage the user input and computing device output. There is no restriction on operating on any particular hardware arrangement and therefore the basic features here may easily be substituted for improved hardware or firmware arrangements as they are developed.

Storage device 2014 is a non-volatile memory and can be a hard disk or other types of computer readable media which can store data that are accessible by a computer, such as magnetic cassettes, flash memory cards, solid state memory devices, digital versatile disks, cartridges, random-access memories (RAMs) 2006, read only memory (ROM) 2008, and hybrids thereof. Storage device 2014 can include services 2016, 2018, and 2020 for controlling processor 2002. Other hardware or software modules are contemplated. Storage device 2014 can be connected to the computing device connection 2012. In one aspect, a hardware module that performs a particular function can include the software component stored in a computer-readable medium in connection with the necessary hardware components, such as processor 2002, connection 2012, output device 2024, and so forth, to carry out the function.

The term “substantially,” in reference to a given parameter, property, or condition, may refer to a degree that one of ordinary skill in the art would understand that the given parameter, property, or condition is met with a small degree of variance, such as, for example, within acceptable manufacturing tolerances. By way of example, depending on the particular parameter, property, or condition that is substantially met, the parameter, property, or condition may be at least 90% met, at least 95% met, or even at least 99% met.

Aspects of the present disclosure are applicable to any suitable electronic device (such as security systems, smartphones, tablets, laptop computers, vehicles, drones, or other devices) including or coupled to one or more active depth sensing systems. While described below with respect to a device having or coupled to one light projector, aspects of the present disclosure are applicable to devices having any number of light projectors and are therefore not limited to specific devices.

The term “device” is not limited to one or a specific number of physical objects (such as one smartphone, one controller, one processing system and so on). As used herein, a device may be any electronic device with one or more parts that may implement at least some portions of this disclosure. While the below description and examples use the term “device” to describe various aspects of this disclosure, the term “device” is not limited to a specific configuration, type, or number of objects. Additionally, the term “system” is not limited to multiple components or specific aspects. For example, a system may be implemented on one or more printed circuit boards or other substrates and may have movable or static components. While the below description and examples use the term “system” to describe various aspects of this disclosure, the term “system” is not limited to a specific configuration, type, or number of objects.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including functional blocks including devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, magnetic or optical disks, USB devices provided with non-volatile memory, networked storage devices, any suitable combination thereof, among others. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some aspects the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, circuits, and algorithm steps described in connection with the aspects disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general-purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium including program code including instructions that, when executed, performs one or more of the methods described above. The computer-readable data storage medium may form part of a computer program product, which may include packaging materials. The computer-readable medium may include memory or data storage media, such as random-access memory (RAM) such as synchronous dynamic random-access memory (SDRAM), read-only memory (ROM), non-volatile random-access memory (NVRAM), electrically erasable programmable read-only memory (EEPROM), flash memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general-purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, such as, a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative aspects of the disclosure include:

Aspect 1. An apparatus for generating map data, the apparatus comprising: at least one memory; and at least one processor coupled to the at least one memory and configured to: process sensor data representative of a scene using a bird's-eye-view (BEV) detector to generate a BEV map of the scene; process the BEV map using a BEV spatial prior model to generate one or more priors; and refine the BEV map, based on the one or more priors, to generate a refined BEV map.

Aspect 2. The apparatus of aspect 1, wherein, to refine the BEV map, the at least one processor is configured to optimize an objective including a detector probability and a prior probability to generate the refined BEV map.

Aspect 3. The apparatus of aspect 2, wherein the detector probability is based on the BEV map and the prior probability comprises one of the one or more priors generated by the BEV spatial prior model.

Aspect 4. The apparatus of aspect 3, wherein, to optimize the objective, the at least one processor is configured to solve an optimization problem based on the detector probability and the prior probability.

Aspect 5. The apparatus of any one of aspects 3 or 4, wherein the detector probability comprises a likelihood that the BEV map is accurate given probabilities determined by the BEV detector.

Aspect 6. The apparatus of any one of aspects 1 to 5, wherein the BEV detector is trained to generate BEV maps based on sensor data.

Aspect 7. The apparatus of any one of aspects 1 to 6, wherein, to generate the BEV map, the BEV detector is configured to: encode the sensor data to generate features; project the features into BEV space to generate projected features; and decode the projected features to generate the BEV map.

Aspect 8. The apparatus of any one of aspects 1 to 7, wherein the BEV map comprises a plurality of pixels, and wherein each pixel of the plurality of pixels comprises a value indicative of a probability that the respective pixel represents a class.

Aspect 9. The apparatus of any one of aspects 1 to 8, wherein the BEV map comprises a plurality of pixels, wherein each pixel of the plurality of pixels comprises a respective vector of values, and wherein a vector of values of a pixel of the plurality of pixels indicates probabilities that the pixel represents classes.

Aspect 10. The apparatus of any one of aspects 1 to 9, wherein the refined BEV map comprises a plurality of pixels, wherein each pixel of the plurality of pixels comprises a respective indication of a class.

Aspect 11. The apparatus of any one of aspects 1 to 10, wherein the BEV spatial prior model comprises a generative likelihood-based machine-learning model.

Aspect 12. The apparatus of any one of aspects 1 to 11, wherein the BEV spatial prior model comprises at least one of: a normalizing flow machine-learning model; a variational autoencoder machine-learning model; or an autoregressive machine-learning model.

Aspect 13. The apparatus of any one of aspects 1 to 12, wherein the BEV spatial prior model is trained using an unsupervised training process based on ground-truth BEV maps.

Aspect 14. The apparatus of anyone of aspects 1 to 13, wherein the sensor data comprises at least one of: image data; light detection and ranging (LIDAR) data; or radio detection and ranging (RADAR) data.

Aspect 15. An apparatus for generating map data, the apparatus comprising: at least one memory; and at least one processor coupled to the at least one memory and configured to: process sensor data representative of a scene using a bird's-eye-view (BEV) detector to generate a BEV map of the scene; and process the BEV map using an enhancer model to generate a refined BEV map.

Aspect 16. The apparatus of aspect 15, wherein the enhancer model is trained using a supervised training process to generate refined BEV maps based on BEV maps.

Aspect 17. The apparatus of aspect 16, wherein the refined BEV maps used in the supervised training process are generated by: processing the BEV maps using a BEV spatial prior model to generate one or more priors; and refining the BEV maps based on the BEV maps and the one or more priors to generate the refined BEV maps.

Aspect 18. The apparatus of aspect 17, wherein the BEV spatial prior model comprises a generative likelihood-based machine-learning model.

Aspect 19. The apparatus of any one of aspects 17 or 18, wherein the BEV spatial prior model is trained using an unsupervised training process based on ground-truth BEV maps.

Aspect 20. An apparatus for generating map data, the apparatus comprising: at least one memory; and at least one processor coupled to the at least one memory and configured to: obtain sensor data representative of a scene; and process the sensor data using a bird's-eye-view (BEV) detector to generate a BEV map of the scene, wherein the BEV detector is trained using priors determined by a BEV spatial prior model.

Aspect 21. The apparatus of aspect 20, wherein the priors are used as a loss function in training the BEV detector.

Aspect 22. The apparatus of any one of aspects 20 or 21, wherein the BEV spatial prior model comprises a generative likelihood-based machine-learning model.

Aspect 23. The apparatus of any one of aspects 20 to 22, wherein the BEV spatial prior model is trained using an unsupervised training process based on ground-truth BEV maps.

Aspect 24. An apparatus for generating map data, the apparatus comprising: at least one memory; and at least one processor coupled to the at least one memory and configured to: encode sensor data to generate features using an encoder of a bird's-eye-view (BEV) detector, wherein the sensor data is representative of a scene; and decode the features using a decoder of a BEV spatial prior model to generate a BEV map of the scene.

Aspect 25. The apparatus of aspect 24, wherein the at least one processor is configured to project the features into BEV space.

Aspect 26. The apparatus of any one of aspects 24 or 25, wherein the BEV spatial prior model comprises an autoencoder.

Aspect 27. The apparatus of any one of aspects 24 to 26, wherein the BEV spatial prior model is trained using an unsupervised training process based on ground-truth BEV maps.

Aspect 28. An apparatus for generating map data, the apparatus comprising: at least one memory; and at least one processor coupled to the at least one memory and configured to: process sensor data representative of a scene using a bird's-eye-view (BEV) detector to generate a BEV map of the scene; and enhance the BEV map using a BEV spatial prior model to generate a refined BEV map.

Aspect 29. The apparatus of aspect 28, wherein the BEV spatial prior model is trained using a supervised training process based on BEV maps and ground-truth BEV maps.

Aspect 30. The apparatus of any one of aspects 28 or 29, wherein the BEV spatial prior model comprises a generative machine-learning model.

Aspect 31. The apparatus of any one of aspects 28 to 30, wherein the BEV spatial prior model comprises at least one of: a diffusion model; or a generative adversarial network (GAN).

Aspect 32. A method for generating map data, the method comprising: processing sensor data representative of a scene using a bird's-eye-view (BEV) detector to generate a BEV map of the scene; processing the BEV map using a BEV spatial prior model to generate one or more priors; and refining the BEV map, based on the one or more priors, to generate a refined BEV map.

Aspect 33. The method of aspect 32, wherein refining the BEV map comprises optimizing an objective including a detector probability and a prior probability to generate the refined BEV map.

Aspect 34. The method of aspect 33, wherein the detector probability is based on the BEV map and the prior probability comprises one of the one or more priors generated by the BEV spatial prior model.

Aspect 35. The method of aspect 34, wherein optimizing the objective comprises solving an optimization problem based on the detector probability and the prior probability.

Aspect 36. The method of any one of aspects 34 or 35, wherein the detector probability comprises a likelihood that the BEV map is accurate given probabilities determined by the BEV detector.

Aspect 37. The method of any one of aspects 32 to 36, wherein the BEV detector is trained to generate BEV maps based on sensor data.

Aspect 38. The method of any one of aspects 32 to 37, wherein, to generate the BEV map, the BEV detector is configured to: encode the sensor data to generate features; project the features into BEV space to generate projected features; and decode the projected features to generate the BEV map.

Aspect 39. The method of any one of aspects 32 to 38, wherein the BEV map comprises a plurality of pixels, and wherein each pixel of the plurality of pixels comprises a value indicative of a probability that the respective pixel represents a class.

Aspect 40. The method of any one of aspects 32 to 39, wherein the BEV map comprises a plurality of pixels, wherein each pixel of the plurality of pixels comprises a respective vector of values, and wherein a vector of values of a pixel of the plurality of pixels indicates probabilities that the pixel represents classes.

Aspect 41. The method of any one of aspects 32 to 40, wherein the refined BEV map comprises a plurality of pixels, wherein each pixel of the plurality of pixels comprises a respective indication of a class.

Aspect 42. The method of any one of aspects 32 to 41, wherein the BEV spatial prior model comprises a generative likelihood-based machine-learning model.

Aspect 43. The method of any one of aspects 32 to 42, wherein the BEV spatial prior model comprises at least one of: a normalizing flow machine-learning model; a variational autoencoder machine-learning model; or an autoregressive machine-learning model.

Aspect 44. The method of any one of aspects 32 to 43, wherein the BEV spatial prior model is trained using an unsupervised training process based on ground-truth BEV maps.

Aspect 45. The method of any one of aspects 32 to 44, wherein the sensor data comprises at least one of: image data; light detection and ranging (LIDAR) data; or radio detection and ranging (RADAR) data.

Aspect 46. A method for generating map data, the method comprising: processing sensor data representative of a scene using a bird's-eye-view (BEV) detector to generate a BEV map of the scene; and processing the BEV map using an enhancer model to generate a refined BEV map.

Aspect 47. The method of aspect 46, wherein the enhancer model is trained using a supervised training process to generate refined BEV maps based on BEV maps.

Aspect 48. The method of aspect 47, wherein the refined BEV maps used in the supervised training process are generated by: processing the BEV maps using a BEV spatial prior model to generate one or more priors; and refining the BEV maps based on the BEV maps and the one or more priors to generate the refined BEV maps.

Aspect 49. The method of aspect 48, wherein the BEV spatial prior model comprises a generative likelihood-based machine-learning model.

Aspect 50. The method of any one of aspects 48 or 49, wherein the BEV spatial prior model is trained using an unsupervised training process based on ground-truth BEV maps.

Aspect 51. A method for generating map data, the method comprising: obtain sensor data representative of a scene; and processing the sensor data using a bird's-eye-view (BEV) detector to generate a BEV map of the scene, wherein the BEV detector is trained using priors determined by a BEV spatial prior model.

Aspect 52. The method of aspect 51, wherein the priors are used as a loss function in training the BEV detector.

Aspect 53. The method of any one of aspects 51 or 52, wherein the BEV spatial prior model comprises a generative likelihood-based machine-learning model.

Aspect 54. The method of any one of aspects 51 to 53, wherein the BEV spatial prior model is trained using an unsupervised training process based on ground-truth BEV maps.

Aspect 55. A method for generating map data, the method comprising: encoding sensor data to generate features using an encoder of a bird's-eye-view (BEV) detector, wherein the sensor data is representative of a scene; and decoding the features using a decoder of a BEV spatial prior model to generate a BEV map of the scene.

Aspect 56. The method of aspect 55, further comprising projecting the features into BEV space.

Aspect 57. The method of any one of aspects 55 or 56, wherein the BEV spatial prior model comprises an autoencoder.

Aspect 58. The method of any one of aspects 55 to 57, wherein the BEV spatial prior model is trained using an unsupervised training process based on ground-truth BEV maps.

Aspect 59. A method for generating map data, the method comprising: processing sensor data representative of a scene using a bird's-eye-view (BEV) detector to generate a BEV map of the scene; and enhancing the BEV map using a BEV spatial prior model to generate a refined BEV map.

Aspect 60. The method of aspect 59, wherein the BEV spatial prior model is trained using a supervised training process based on BEV maps and ground-truth BEV maps.

Aspect 61. The method of any one of aspects 59 or 60, wherein the BEV spatial prior model comprises a generative machine-learning model.

Aspect 62. The method of any one of aspects 59 to 61, wherein the BEV spatial prior model comprises at least one of: a diffusion model; or a generative adversarial network (GAN).

Aspect 63. A non-transitory computer-readable storage medium having stored thereon instructions that, when executed by at least one processor, cause the at least one processor to perform operations according to any of aspects 32 to 62.

Aspect 64. An apparatus for providing virtual content for display, the apparatus comprising one or more means for perform operations according to any of aspects 32 to 62.

What is claimed is:

1. An apparatus for generating map data, the apparatus comprising:
at least one memory; and
at least one processor coupled to the at least one memory and configured to:
process sensor data representative of a scene using a bird's-eye-view (BEV) detector to generate a BEV map of the scene;
process the BEV map using a BEV spatial prior model to generate one or more priors; and
refine the BEV map, based on the one or more priors, to generate a refined BEV map.

2. The apparatus of claim 1, wherein, to refine the BEV map, the at least one processor is configured to optimize an objective including a detector probability and a prior probability to generate the refined BEV map.

3. The apparatus of claim 2, wherein the detector probability is based on the BEV map and the prior probability comprises one of the one or more priors generated by the BEV spatial prior model.

4. The apparatus of claim 3, wherein, to optimize the objective, the at least one processor is configured to solve an optimization problem based on the detector probability and the prior probability.

5. The apparatus of claim 3, wherein the detector probability comprises a likelihood that the BEV map is accurate given probabilities determined by the BEV detector.

6. The apparatus of claim 1, wherein the BEV detector is trained to generate BEV maps based on sensor data.

7. The apparatus of claim 1, wherein, to generate the BEV map, the BEV detector is configured to:
encode the sensor data to generate features;
project the features into BEV space to generate projected features; and
decode the projected features to generate the BEV map.

8. The apparatus of claim 1, wherein the BEV map comprises a plurality of pixels, and wherein each pixel of the plurality of pixels comprises a value indicative of a probability that the respective pixel represents a class.

9. The apparatus of claim 1, wherein the BEV map comprises a plurality of pixels, wherein each pixel of the plurality of pixels comprises a respective vector of values, and wherein a vector of values of a pixel of the plurality of pixels indicates probabilities that the pixel represents classes.

10. The apparatus of claim 1, wherein the refined BEV map comprises a plurality of pixels, wherein each pixel of the plurality of pixels comprises a respective indication of a class.

11. The apparatus of claim 1, wherein the BEV spatial prior model comprises a generative likelihood-based machine-learning model.

12. The apparatus of claim 1, wherein the BEV spatial prior model comprises at least one of:
a normalizing flow machine-learning model;
a variational autoencoder machine-learning model; or
an autoregressive machine-learning model.

13. The apparatus of claim 1, wherein the BEV spatial prior model is trained using an unsupervised training process based on ground-truth BEV maps.

14. The apparatus of claim 1, wherein the sensor data comprises at least one of:
image data;
light detection and ranging (LIDAR) data; or
radio detection and ranging (RADAR) data.

15. An apparatus for generating map data, the apparatus comprising:
at least one memory; and
at least one processor coupled to the at least one memory and configured to:
process sensor data representative of a scene using a bird's-eye-view (BEV) detector to generate a BEV map of the scene; and
process the BEV map using an enhancer model to generate a refined BEV map.

16. The apparatus of claim 15, wherein the enhancer model is trained using a supervised training process to generate refined BEV maps based on BEV maps.

17. The apparatus of claim 16, wherein the refined BEV maps used in the supervised training process are generated by:
processing the BEV maps using a BEV spatial prior model to generate one or more priors; and
refining the BEV maps based on the BEV maps and the one or more priors to generate the refined BEV maps.

18. The apparatus of claim 17, wherein the BEV spatial prior model comprises a generative likelihood-based machine-learning model.

19. The apparatus of claim 17, wherein the BEV spatial prior model is trained using an unsupervised training process based on ground-truth BEV maps.

20. An apparatus for generating map data, the apparatus comprising:
at least one memory; and
at least one processor coupled to the at least one memory and configured to:
obtain sensor data representative of a scene; and
process the sensor data using a bird's-eye-view (BEV) detector to generate a BEV map of the scene, wherein the BEV detector is trained using priors determined by a BEV spatial prior model.
